(19) United States
(12) Patent Application Publication
(10) Pub. No.: US 2023/0370197 A1
(43) Pub. Date: Nov. 16, 2023

(54) COMMUNICATION SYSTEMS

(71) Applicant: Imperial College Innovations Limited, London (GB)

(72) Inventors: Deniz Gunduz, Reading (GB); Mehmet Emre Ozfatura, London (GB); Yulin Shao, London (GB)

(21) Appl. No.: 18/318,652

(22) Filed: May 16, 2023

(30) Foreign Application Priority Data
May 16, 2022 (GB) 2207152.6

(51) Int. Cl. H04L 1/00

(52) U.S. Cl. CPC H04L 1/0073; H04L 1/0043

(57) ABSTRACT

Examples relate to machine readable storage storing instructions arranged, when processed, to realise feedback code encoding and decoding of a source bitstream using attention neural networks.

### BACKGROUND

The present application claims priority from UK patent application no. 2207152.6, filed May 16, 2022; the content of which is incorporated herein by reference for all purposes.

Feedback codes are a class of error correction codes that protect a message transmitted from a terminal A to another terminal B over a noisy communication channel. In contrast to classical forward error correction codes, feedback codes leverage the feedback signal from terminal B to terminal A to aid encoding at terminal A, and the encoding proceeds iteratively such that each transmitted symbol depends not only the intended message, but also all the feedback signals received so far.

### BRIEF INTRODUCTION OF THE DRAWINGS

Examples will be described with reference to the accompanying drawings in which

FIG. 1 shows an example communication system comprising a transmitter and a receiver using feedback coding;

FIG. 2 shows the structure of an encoder and a decoder;

FIG. 3 illustrates Block Attention Feedback coding;

FIG. 4 depicts a flowchart of Block Attention Feedback coding;

FIG. 4B shows a layer of the encoder of FIG. 2;

FIG. 5 shows the output of an accumulator of a transmitter;

FIG. 6 illustrates the structure of an encoder;

FIG. 7 depicts the structure of the encoder of FIG. 6 in greater detail;

FIG. 8 shows an output of an accumulator at a receiver;

FIG. 9 illustrates the structure of a decoder at a receiver;

FIG. 10 depicts the structure of the decoder of FIG. 9 in greater detail;

FIG. 11 shows the structure of a belief neural network;

FIG. 12 illustrates iterative decoding at a receiver;

FIG. 13 depicts performance comparisons of Generalised Block Attention Feedback coding with other forms of feedback coding;

FIG. 14 illustrates a flowchart to generate training data;

FIG. 15 depicts a flowchart for modulating data;

FIG. 16 shows a further flowchart for modulating data;

FIG. 17 illustrates a flow chart for active feedback data modulation; and

FIG. 18 shows machine readable storage storing machine readable instructions.

### DETAILED DESCRIPTION

The following notation is used:
bold lower case and capital bold letters denote vectors and matrices respectively, i.e., v and V,
capital calligraphic letters, e.g., V to denote a set corresponding to V,
subscript indexing is used to identify the particular indices in a vector or a matrix, i.e., vᵢ is the i^{th} element of vector v and v_{i:j} is a vector containing the elements of the vector v from the i^{th} index to the j^{th} index,
v_{(S)} refers to a sub-vector of v that contains the elements in the given set of indices S, for a given matrix V,
for a matrix subscript refers to a particular row, e.g., Vᵢ is the i^{th} row of matrix V,
a superscript for a vector or matrix represents an index for time/iteration, i.e., v^{(t)}, particularly when it is changing over time/iterations,
[symbol] stands for the set of real numbers and
[symbol] stands for the real Gaussian distribution.

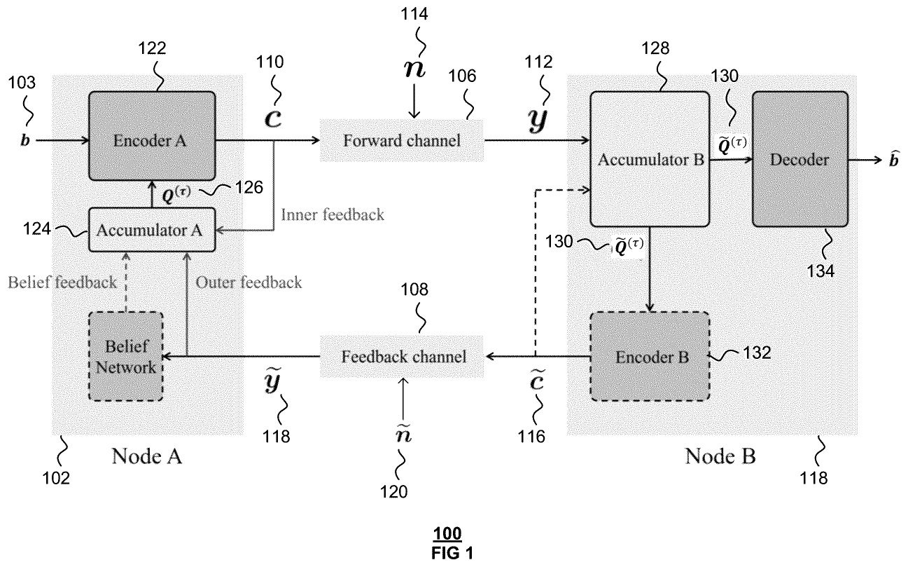

FIG. 1 illustrates a schematic view of a point to point communication system 100 comprising two nodes A 102 and B 104. The two nodes 102 and 104 are a transmitter and a receiver, respectively.

The communication goal is to deliver a vector of K bits b∈{0,1}^{K} 103 reliably from node A 102 to node B 104. Therefore, nodes A 102 and B 104 are arranged to communicate over T interactions. In the τ^{th} interaction, τ=1, 2, . . . , T, node A 102 transmits a packet of q^{(τ)} symbols c^{(τ)} to node B 104 over the forward channel. In turn, node B 104 feeds back a packet of \tilde{q}^{(τ)} symbols \tilde{c}^{(τ)} to node A 102 over the feedback channel. In the examples described herein, it will be assumed that q^{(τ)}=\tilde{q}^{(τ)}=q, ∀τ.

Node A 102 transmits, via the forward channel 106, a vector of symbols c∈ [symbol] ^{q} 110. The received signal or symbols at Node B 104 is given by y=c+n 112, where n∈ [symbol] ^{q} 114 is a vector of Additive White Gaussian Noise (AWGN), the elements of which have a Gaussian distribution [symbol] (0,σ_{f}²) in an independent and identically distributed (i.i.d.) manner.

Node B 104 feeds back a vector of symbols \tilde{c}∈ [symbol] ^{q} 116 to node A 102. The received signal or received symbols, at node A 102, are given by \tilde{y}=\tilde{c}+ñ 118, where the elements of the AWGN ñ∈ [symbol] ^{q} 120 have a Gaussian distribution [symbol] (0,σ_{b}²) in an independent and identically distributed (i.i.d.) manner.

Nodes A 102 and B 104 are arranged to operate at a code rate

$$R {=}^{△} K / N ,$$

where N=Tq such that

$$R {=}^{△} \frac{K}{N} = \frac{K}{Tq} .$$

In the examples described, nodes A 102 and B 104 can be subject to average power constraints P and \tilde{P} respectively:

$$\frac{1}{N} E ( {\sum }_{τ = 1}^{T} 〈 {( {c}^{( τ )} )}^{⊤} , {c}^{( τ )} 〉 ) \leq P ; and \frac{1}{N} E ( {\sum }_{τ = 1}^{T} 〈 {( {\tilde{c}}^{( τ )} )}^{⊤} , {\tilde{c}}^{( τ )} 〉 ) \leq \tilde{P} ,$$

where E is the expectancy. Therefore, the signal-to-noise ratio (SNR) of the feedforward 106 and feedback 108 channels are respectively given by

$$S N {R}_{f} {=}^{△} \frac{P}{{σ}_{f}^{2}} and S N {R}_{b} {=}^{△} \frac{P}{{σ}_{b}^{2}} .$$

Node A 102 comprises an encoder 122, and an accumulator 124. The encoder 122 is arranged to produce the packet of q^{(τ)} symbols c^{(τ)} 110. The encoder 122 produces the q^{(τ)} symbols c^{(τ)} 110 from a number of inputs. Examples can be realised in which the number of inputs comprise an information vector Q^{(τ)} 126. The information vector 126 is also known as a knowledge vector. The information vector Q^{(τ)} 126 is derived from the accumulator 124 and the bitstream b 103 to be modulated. The accumulator 124 receives the feedback symbols \tilde{y}=\tilde{c}+ñ 118 and constructs the information vector Q^{(τ)} 126 for processing by the encoder 122 as follows:

Q^{(τ)}=[b,c⁽¹⁾, . . . ,c^{(τ-1)},\tilde{y}⁽¹⁾, . . . ,\tilde{y}^{(τ)}] (6).

Node B 104 comprises an accumulator 128. The accumulator 128 is arranged to produce the packet of \tilde{q}^{(τ)} symbols \tilde{c}^{(τ)} 116. The accumulator 122 produces the packet of \tilde{q}^{(τ)} symbols \tilde{c}^{(τ)} 116 from at least one input. Examples can be realised in which the at least one input comprises an information vector \tilde{Q}^{(τ)} 130. The information vector 130 is also known as a knowledge vector. The information vector \tilde{Q}^{(τ)} 130 is derived by accumulator 128 from the received signals y⁽¹⁾, . . . , y^{(τ)} 112. Examples can be realised, using active feedback, in which the information vector \tilde{Q}^{(τ)} 130 is derived from previous feedback symbols \tilde{c}⁽¹⁾, . . . , \tilde{c}^{(τ-1)} as well as the received signals y⁽¹⁾, . . . , y^{(τ)} 112. Examples that provide active feedback can be provided in which node B comprises an encoder 132. The encoder 132 is arranged to derive the feedback symbols \tilde{c}⁽¹⁾, . . . , \tilde{c}^{(τ)} 116 from the information vector \tilde{Q}^{(τ)} 130. Therefore, examples, in the case of active feedback, can be realised in which the information vector \tilde{Q}^{(τ)} 130 is given by

\tilde{Q}^{(τ)}=[\tilde{c}⁽¹⁾, . . . ,\tilde{c}^{(τ-1)},y⁽¹⁾, . . . ,y^{(τ)}] (7).

Examples, in the case of passive feedback, can be realised in which the information vector \tilde{Q}^{(τ)} 130 is given by

\tilde{Q}^{(τ)}=[y⁽¹⁾, . . . ,y^{(τ)}].

The encoders 128 and 132 are arranged to encode the forward channel and feedback channels via respective encoding mechanisms M^{(τ)} and \tilde{M}^{(τ)}, which, for each communication block τ, are realised via, respectively,

M^{(τ)}:Q^{(τ)}→c^{(τ)}∈R^{q}^{_{τ}} (8)

and

\tilde{M}^{(τ)}:\tilde{Q}^{(τ)}→\tilde{c}^{(τ)}∈R^{\tilde{q}}^{_{τ}} (9).

Node B 104 also comprises a decoder 134. The decoder 134 is arranged to predict the original bitstream b 103 from the information vector \tilde{Q}^{(τ)} 130 following a decoding mechanism D given by

D:\tilde{Q}^{(τ)}→\hat{b}∈{0,1}^{K} (10).

As indicated above, the encoder 132 at node B 104 actively processes the information vector \tilde{Q}^{(τ)} 130 via \tilde{M}^{(τ)} to generate the vector of symbols \tilde{c}^{(τ)} 116 transmitted to node A 102 over the feedback channel 108. In the case of examples that use passive feedback, the encoder 132 at node B 104 implements a relay mechanism in which the information vector \tilde{Q}^{(τ)} 130, via \tilde{M}^{(τ)}, generates the vector of symbols \tilde{c}^{(τ)} 116 transmitted to node A 102 over the feedback channel 108 using

\tilde{M}^{(τ)}:\tilde{Q}^{(τ)}→\tilde{c}^{(τ)}=αy^{(τ)}+αn^{(τ)} (14)

where α is a scalar that can be used to scale the received vector y^{(τ)} to the above average power constraint, if imposed. In the cases of passive feedback, \tilde{q}^{(τ)}=q^{(τ)}.

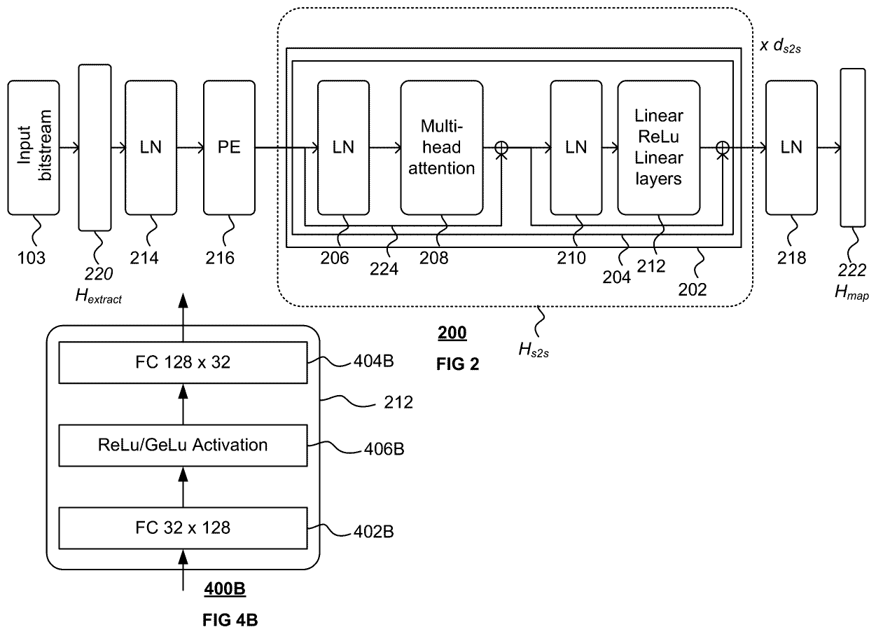

Referring to FIG. 2, there is shown a view 200 of the structure of the encoder 122 and decoder 134. The encoder 122 has a structure that is the same as the structure of the encoding layer in “Attention is all you need”, Ashish Vaswani, Noam Shazeer, Niki Parmar, Jakob Uszkoreit, Llion Jones, Aidan N Gomez, Ł ukasz Kaiser, and Illia Polosukhin. In I. Guyon, U. V. Luxburg, S. Bengio, H. Wallach, R. Fergus, S. Vishwanathan, and R. Garnett, editors, Advances in Neural Information Processing Systems, volume 30. Curran Associates, Inc., 2017. Therefore, the encoder 122 comprises an encoding block 202. The encoding block 202 comprises multiple encoding layers 204. In the example depicted, the encoding block 202 comprises dₛ₂ₛ encoding layers 204, where dₛ₂ₛ≥1. Each encoding layer 204 comprises a layer normalisation layer 206, a self-attention neural network 208, a further layer normalisation layer 210, and a linear-ReLu-Linear layer 212.

A further layer normalisation layer 214 is provided to receive the bitstream b 103. The output of layer 214 is coupled to a position encoder 216. The output of the Linear-ReLu-Linear layer 212 is coupled to a further layer normalisation layer 218.

The encoder layers 202 of FIG. 2 are arranged to map respective sequences of l vectors of size dᵢₙ into respective sequences of vectors of size dₒᵤₜ. The encoder layers are also known as sequence to sequence neural networks that implement attention-based neural encoding. Therefore, the encoding layer realises the following mapping: H_{encoder}:V=(V₁, . . . , Vₗ)→\tilde{V}=(\tilde{V}₁, . . . , \tilde{V}ₗ) such that Vᵢ∈ [symbol] ^{d}^{ᵢₙ}, \tilde{V}ᵢ∈ [symbol] ^{d}^{ₒᵤₜ}. It can be appreciated that relative to the encoder layer of “Attention is all you need”, the encoder 122 comprises an additional two layers; namely, a first feature extractor layer 220, which comprises the normalisation layer 214 and the position encoding layer 216, and a symbol mapping layer 222. The feature extractor layer 220 extracts a feature vector of size dᵢₙ from the feature matrix Q^{(τ)}. The symbol mapping layer 222 maps the output of the encoding block 202 into a vector c^{(τ)} of length q symbols for transmission to node B 104.

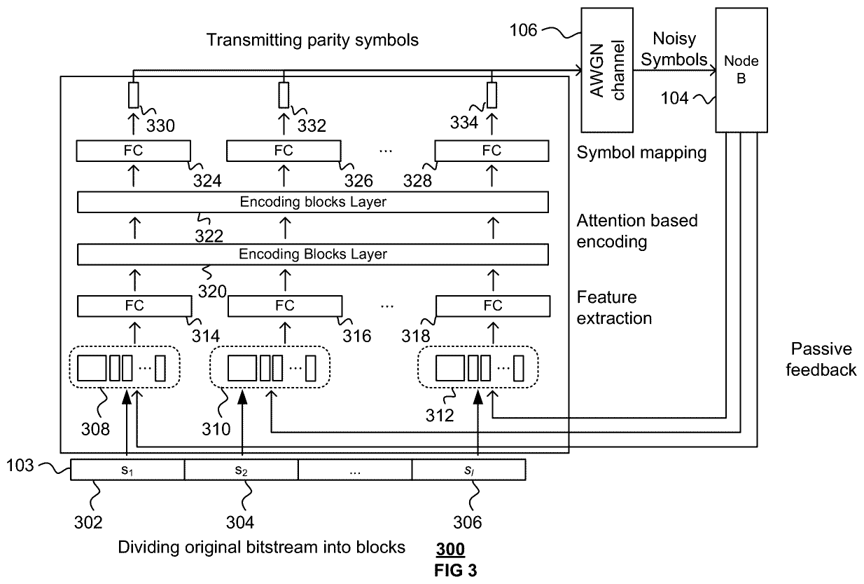

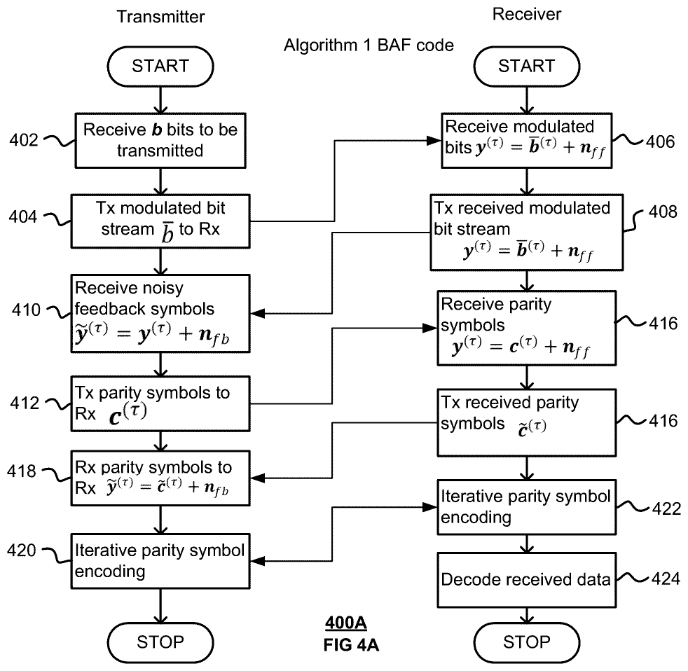

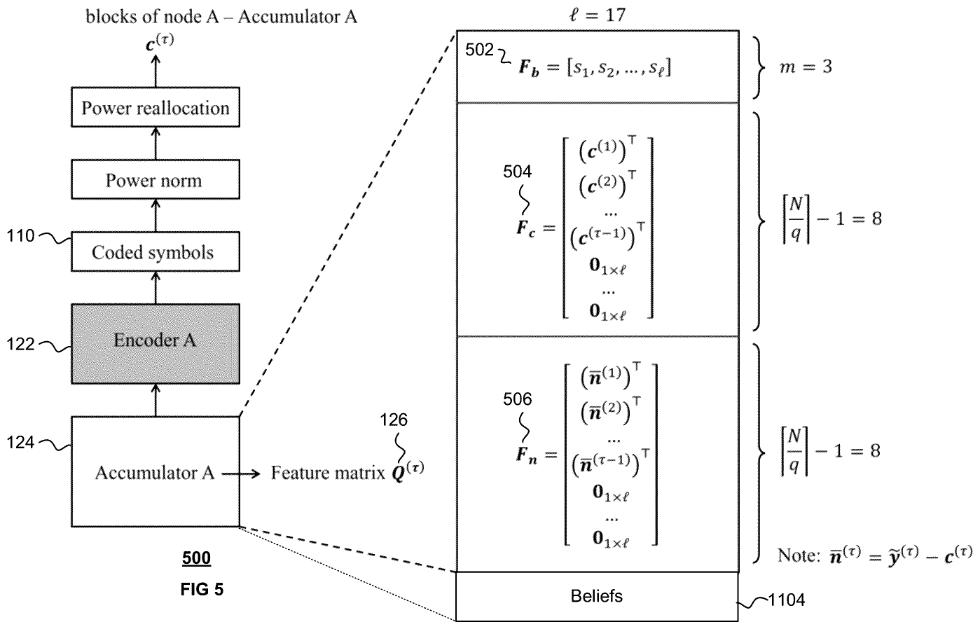

An example implementation of systematic, passive, feedback encoding and decoding will be described with reference to FIG. 3, which is known as Block Attention Feedback (BAF) coding. During an initial phase, a predetermined modulation is used for transmitting the bitstream b 103 to node B 104. More particularly, BPSK modulation is employed to transmit the original bitstream b 103 to node B 104. A second phase generates the symbols using a deep neural network. The overall flow of such block attention feedback coding is described below in Algorithm 1, BAF code, as depicted in FIG. 4.

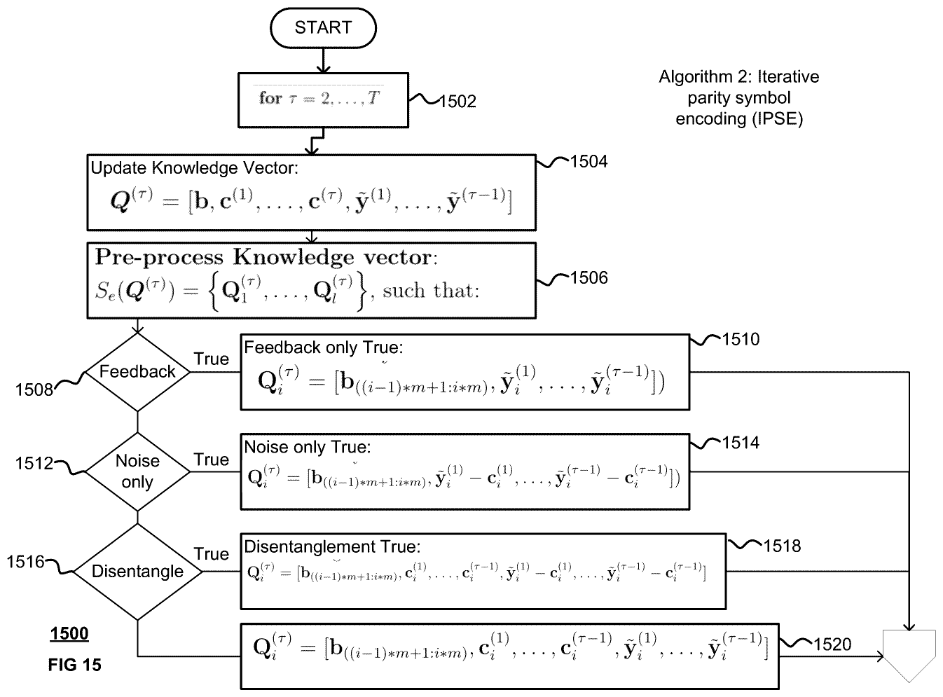

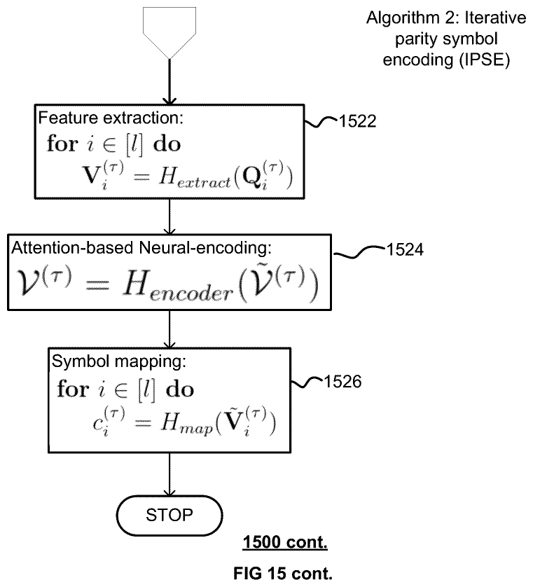

```
  Algorithm 1 BAF code:
  1. Transmitter side/Node A:
  2. Phase 0:
  3. Send BPSK modulated bit stream
  ${M}^{( 1 )} : {Q}^{( 1 )} = b {⟶}^{BPSK} {c}^{( 1 )} = \overline{b} = 2 * b - 1 ( 15 )$
  4. Phase 1:
  5. Receive the feedback symbols and execute the IPSE algorithm, of
Algorithm 2 or FIG. 15
  6. Receive side/Node B:
  7. Relay the received block of noisy symbols to Node A,
  ${\tilde{M}}^{( τ )} : {\tilde{Q}}^{( τ )} {⟶}^{relay} {\tilde{c}}^{( τ )} = α {y}^{( τ )} + α {n}^{( τ )} . ( 14 )$
```

Although the above uses BPSK modulation to send the bitstream, examples are not limited thereto. Examples can be realised in which some other form of higher order modulation is used such as, for example, QPSK, 8-PSK, QAM etc. Since the encoder block comprises dₛ₂ₛ layers, the parity symbols can be generated in parallel by dividing the bitstream b 103 into multiple blocks with each layer of the encoder block being arranged to process a respective block of the bitstream b 130. The process of encoding the bitstream b 130 is shown in FIG. 3.

Referring to FIG. 3, there is shown a view 300 of parallel encoding of the bitstream b 130. The bitstream b 130 is divided into l blocks 302 to 306 each of m bits such that l·m=K. Feedback symbols corresponding to each block are appended to respective blocks to form input vectors 308 to 312 to respective feature extractor layers 314 to 318. The feature extractor layers each correspond to the above-described feature extractor layer 220. The feature extractor layers outputs are fed to respective encoding blocks of the depicted encoding blocks layers 320 to 322. The encoding blocks layers 320 to 322 feed multiple possible symbols into respective fully connected layers 324 to 328. The fully connected layers 324 to 328 reduce the multiple possible symbols to the symbol vector c^{(τ)} for transmission to node B 104. The symbol vector c^{(τ)} comprises symbols 330 to 334 from each of the fully connected layers 324 to 328. The fully connected layers 324 to 328 correspond to the above-described layer normalisation layer 218 or the mapping layer 222 that implements Hₘₐₚ as will be described below.

It will be appreciated that a total of l=K/m symbols are transmitted at each iteration corresponding to the l blocks of information bits of the bitstream b 130. The foregoing is repeated until n parity symbols have been transmitted for each block. It will be appreciated that the above gives a coding rate of R=m/(m+n) and requires

$$T = n + 1 = \frac{m}{R} - m + 1$$

communication blocks. Therefore, the rate of a code can be adjusted by changing the block size m and the number of parity symbols per block n. Repeating the process results in iterative party symbol encoding, which is presented in Algorithm 2 below and also illustrated in, and described with reference to, FIG. 15.

Algorithm 2 Iterative parity symbol encoding (IPSE)

| | |
|---|---|
| 1: | for τ = 2, . . . , T do # Generate 1 parity symbol per block at each pass |
| 2: | Update Knowledge vector: |
| 3: | Q^{(τ)} = [b, c⁽¹⁾, . . . , c^{(τ-1)}, \tilde{y}⁽¹⁾, . . . , \tilde{y}^{(τ-1)}] |
| 4: | Pre-process Knowledge vector: |
| 5: | Sₑ(Q^{(τ)}) = {Qₗ^{(τ)}, . . . , Qₗ^{(τ)}}, such that: |
| 6: | if Feedback-only is True then |
| 7: | Qᵢ^{(τ)} = [b_{((i-1)m+1:im)}, \tilde{y}ᵢ⁽¹⁾, . . . , \tilde{y}ᵢ^{(τ-1)}] |
| 8: | else if Noise-only is True then |
| 9: | Qᵢ^{(τ)} = [b_{((i-1)m+1:im)}, \tilde{y}ᵢ⁽¹⁾ − cᵢ⁽¹⁾ , . . . , \tilde{y}ᵢ^{(τ-1)} − cᵢ^{(τ-1)}] |
| 10: | else if Disentangle is True then |
| 11: | Qᵢ^{(τ)} = [b_{((i-1)m+1:im)}, cᵢ⁽¹⁾, . . . , cᵢ^{(τ-1)}, \tilde{y}ᵢ⁽¹⁾ − cᵢ⁽¹⁾, . . . , \tilde{\tilde{y}}ᵢ^{(τ-1)} − cᵢ^{(τ-1)}] |
| 12: | else |
| 13: | Qᵢ^{(τ)} = [b_{((i-1)m+1:im)}, cᵢ⁽¹⁾, . . . , cᵢ^{(τ-1)}, \tilde{y}ᵢ⁽¹⁾, . . . , \tilde{y}ᵢ^{(τ-1)}] |
| 14: | Feature extraction: |
| 15: | for i ϵ [l] do |
| 16: | Vᵢ^{(τ)} = H_{extract}(Qᵢ^{(τ)}) |
| 17: | Attention-based Neural-encoding:V^{(τ)} = H_{encoder} (\tilde{V}^{(τ)}) |
| 18: | Symbol mapping: |
| 19: | for i ϵ [l] do |
| 20: | cᵢ^{(τ)} = Hₘₐₚ(\tilde{V}ᵢ^{(τ)}) |

At line 1, a for loop is established so that a single parity symbol is generated per block at each pass. The knowledge vector Q^{(τ)} is updated using the bitstream 103, the parity symbols transmitted thus far and the received feedback symbols or signals received thus far. The knowledge vector Q^{(τ)} is pre-processed at steps 4 to 13, as will be described below. Feature extraction occurs at lines 14 to 16, attention-based neural-encoding is implemented at line 17 and symbol mapping is determined at lines 19 and 20.

Referring to line 5, Sₑ(⋅) defines how the knowledge vector is pre-processed and fed to the deep neural network (DNN) architecture. Firstly, Sₑ(⋅) generates l equal-sized knowledge vectors, i.e., Sₑ(Q^{(τ)})={Qᵢ^{(τ)}, . . . , Qₗ^{(τ)}}, each of which corresponds to respective different blocks.

The above Algorithm 2 presents four ways to pre-process the knowledge vector, which are expressed in lines 7, 9, 11, and 13.

A first way to pre-process the knowledge vector is given in line 7, in which the knowledge vector Q^{(τ)} is arranged to comprise a current or respective block, b_{((i-1)*m+1:i*m)}, of the bitstream b together with the thus far, or current, received feedback signals \tilde{y}ᵢ⁽¹⁾, . . . , \tilde{y}ᵢ^{(τ-1)}.

A second way to pre-process the knowledge vector Q^{(τ)} is given in line 9. It should be noted that node A 102, by subtracting the vector of the symbols c^{(τ)} 110 from the received noisy version of the feedback symbols \tilde{y}^{(τ)} gives a cumulative noise vector n̅^{(τ)}, that is, n̅^{(τ)}=\tilde{y}^{(τ)}−c^{(τ)}=n^{(τ)}+ñ^{(τ)}. Including the noise, n̅^{(τ)}, associated with feedback symbols as part of the knowledge vector Q^{(τ)} is known as the disentanglement of the feedback network. An example can be realised, as will be appreciated from line 9 of Algorithm 2, in which only the cumulative noise vector ñ^{(τ)} is added to the knowledge vector Q^{(τ)}. An advantage of disentanglement is that it allows flexibility in expressing accumulated estimated noise realisations, which supports improved noise suppression that, in turn, supports improved feature extraction.

A third way to pre-process the knowledge vector Q^{(τ)} is given in line 11. In the third example, the knowledge vector is constructed to comprise a current or respective block, b_{((i-1)*m+1:i*m)}, of the bitstream b together with the thus far, or current, transmitted symbols cᵢ⁽¹⁾, . . . , cᵢ^{(τ-1)} and the above-described cumulative noise vector \tilde{y}^{(τ)}−c^{(τ)}=n̅^{(τ)}=n^{(τ)}+ñ^{(τ)}=\tilde{y}ᵢ⁽¹⁾−cᵢ⁽¹⁾, . . . , \tilde{y}ᵢ^{(τ)}−cᵢ^{(τ-1)}.

A fourth way to construct the knowledge vector Q^{(τ)} is given in line 13. In the fourth example, the knowledge vector is constructed to comprise a current, or respective, block, b_{((i-1)*m+1:i*m)}, of the bitstream b together with the thus far, or current, transmitted symbols cᵢ⁽¹⁾, . . . , cᵢ^{(τ-1)} and together with the thus far, or current, received feedback signals \tilde{y}ᵢ⁽¹⁾, . . . , \tilde{y}ᵢ^{(τ-1)}.

The encoder architecture depicted in FIG. 2 comprises a sequence of multiple encoder layers of the transformer architecture described in “Attention is all you need”. The structure of a single encoder layer is shown in FIG. 2, which comprises three aspects that are a path 224 that has no transformations, a multi-head attention module 208, and the layer normalisation layer or module 210. An example of the feedforward layer 212 is shown in FIG. 4B. The feedforward layer 212 comprises two fully connected layers (FC) 402B and 404B with a ReLu activation layer 406B between the two fully connected layers 402B and 404B.

Examples of the encoder can be realised in which the layer normalisation module 210 can be implemented with different orders, in particular, examples can provide either post-normalisation or pre-normalisation. Pre- and post-layer normalisation are described in detail in

Ruibin Xiong, Yunchang Yang, Di He, Kai Zheng, Shuxin Zheng, Chen Xing, Huishuai Zhang, Yanyan Lan, Liwei Wang, and Tie-Yan Liu. “On layer normalization in the transformer architecture”. CoRR, abs/2002.04745, 2020, which is incorporated herein by reference.

Examples can be realised in which the encoder uses pre-layer normalisation to stabilise gradient flow. Locating the layer normalisation inside any residual blocks allows training to be performed without a warm-up stage and supports faster training convergence.

It will be appreciated also that the mask that is used in transformers as described in “Attention is all you need” is not used in the example encoders and decoders described herein. The ability to remove the use of masks follows from not using sequential processing in the input. Furthermore, the examples described herein feature extractor 220 and symbol mapper 222 are realised as fully connected layers.

Examples of the decoder 134 have an identical architecture to examples of the encoder 122 with the exception that decoding is not performed in an iterative manner.

Although examples can be realised that use a two-phase communication protocol, such as described above in Algorithm 1, examples are not limited to such an arrangement. Examples can be realised in which the first phase in which the modulated symbols corresponding to the bitstream b 130 are not transmitted in advance of the generating symbols using feedback. In such examples, node A 102 directly communicates parity symbols and receives corresponding feedback symbols. Examples of the Block Attention Feedback codes that do not use an initial phase will be known as Generalised Block Attention Feedback (GBAF) codes.

For GBAF codes, since the initial phase is removed, examples use T=m+n communication blocks to obtain the same transmission or coding rate of R=m/(m+n). In examples of GBAF, all iterations use the IPSE algorithm, that is, Algorithm 2, including when τ=1, such that line 1 of Algorithm 2 becomes

for τ=1, . . . , T do # Generate 1 parity symbol per block at each pass.

Referring again to FIG. 4, for examples that use a single phase, that is, for examples of GBAF, feature extraction by the feature extractor 220 can be improved, especially in a low SNR regime of the forward channel, i.e., for an SNR regime of −1 dB. Feature extraction is performed on the knowledge vector. Accordingly, examples can be realised that use a number of fully connected layers together with an activation layer. In the example depicted in FIG. 4, two fully connected layers 402 and 404 are used together with an activation layer to reduce or prevent large noise realisations from dominating, or otherwise interfering with extracted features. Examples can be realised in which the activation layer is a Rectified Linear Unit (ReLu) layer or a Gaussian Error Linear Unit (GeLu) layer 406. Noise suppression can, therefore, be improved by having a number of layers to suppress noise. Although the example depicted in FIG. 4 uses two fully connected layers 402 and 404 with an activation layer disposed in between, examples are not limited to such an arrangement. Examples can be realised in which a number of activation layers are disposed between respective pairs of fully connected layers.

Referring to FIG. 5, there is shown a view 500 of an example of the accumulator 124 generating the knowledge vector or matrix Q^{(τ)} 126. In the examples depicted in FIGS. 5 to 11, the following assumptions prevail: K=51, N=153, m=3, l=┌K/m┐, q=l=17, T=┌N/q┐=9 and that Disentanglement applies. It will be appreciated that examples are not limited to the above values. Examples can equally well be realised that use other values.

The accumulator 124 outputs the feature matrix Q^{(τ)} 126 of dimension

$$lx [ m + 2 ( ⌈ \frac{N}{q} ⌉ - 1 ) ]$$

to the encoder 122. The feature matrix Q^{(τ)} 126 comprises:

the bitstream b 103 is divided into l=17 blocks each having a length of m=3, which gives a vector F_{b}=[s₁, s₂, . . . sₗ] 502,

a symbols vector of previously transmitted symbols

$${F}_{c} = [ \begin{matrix}{( {c}^{( 1 )} )}^{⊤} \\ {( {c}^{( 2 )} )}^{⊤} \\ … \\ \begin{matrix}{( {c}^{( τ ‐ 1 )} )}^{⊤} \\ …\end{matrix} \\ \begin{matrix}{0}_{1 xl} \\ …\end{matrix} \\ {0}_{1 xl}\end{matrix} ]$$

504, and

a vector of cumulative noise vectors

$${F}_{n} = [ \begin{matrix}{( {\overline{n}}^{( 1 )} )}^{⊤} \\ {( {\overline{n}}^{( 2 )} )}^{⊤} \\ … \\ {( {\overline{n}}^{( τ ‐ 1 )} )}^{⊤} \\ \begin{matrix}… \\ {0}_{1 xl} \\ …\end{matrix} \\ {0}_{1 xl}\end{matrix} ]$$

506.

The feature matrix Q^{(τ)} 126 is fed to the encoder 122.

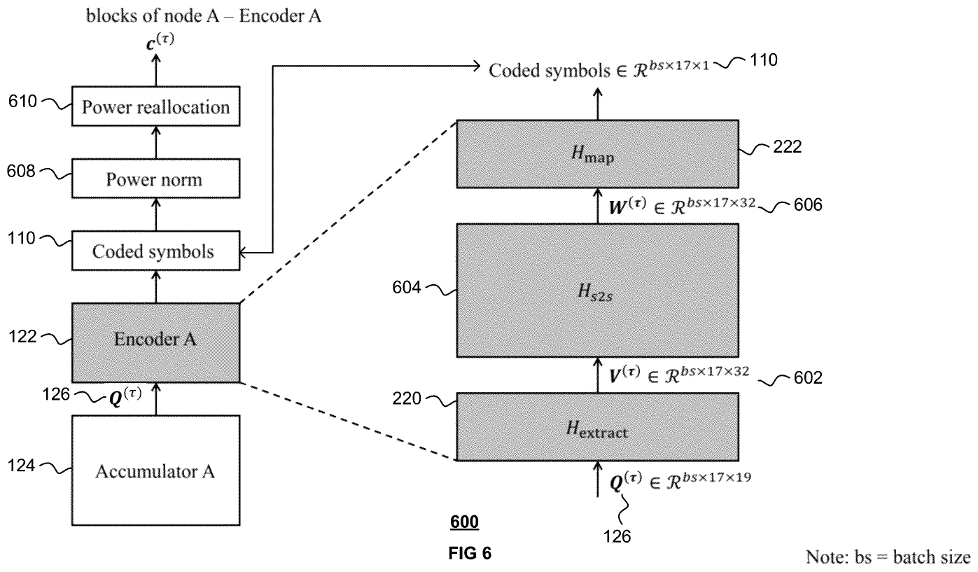

Referring to FIG. 6, there is shown a view 600 of an example of the encoder 122 generating a plurality of coded symbols 110 from the knowledge matrix Q^{(τ)} 126 output by the accumulator 124.

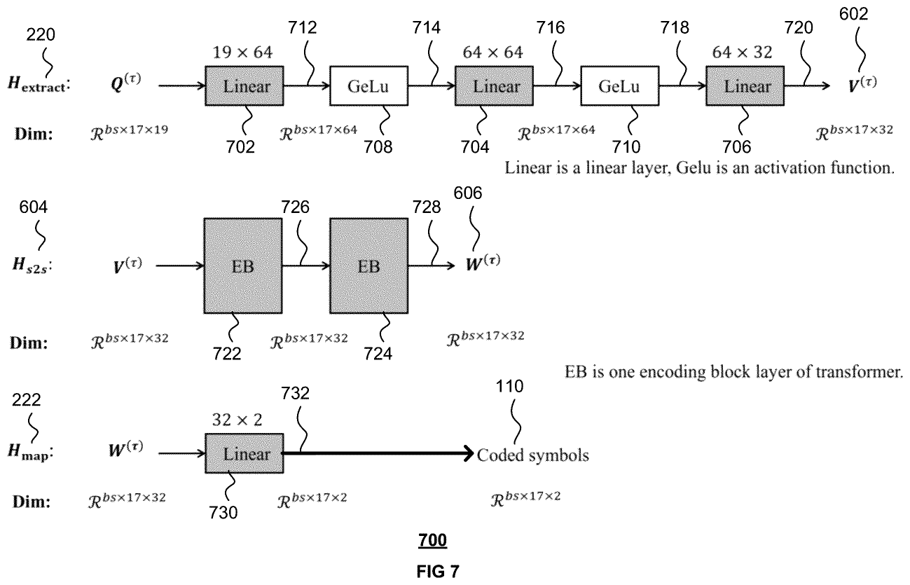

The feature matrix Q^{(τ)} 126 is input to the feature extractor 220. The feature extractor neural network 220 produces an extracted features matrix V^{(τ)}∈R^{bs×17×32} 602. Further detail on the structure of the feature extractor neural network is given in FIG. 7. The extracted features matrix 602 is input to a sequence to sequence neural network 604, Hₛ₂ₛ, as described above with reference to FIG. 2. The structure of the sequence to sequence neural network 604 is given in FIG. 7. The sequence to sequence neural 604 network is arranged to process the extracted features matrix V^{(τ)} 602 to produce a possible symbol matrix W^{(τ)}∈R^{bs×17×32} 606. The possible symbol matrix WM 606 comprises multiple sets of possible symbols for transmission to node B 104. Each set comprises multiple possible symbols for each symbol to be transmitted to node B 104. Examples can be realised in which bs=8192. However, examples are not limited to bs=8192. Examples can be realised in which bs takes other values depending on the available computational resources.

The possible symbols matrix WM 606 is output to a symbol mapping neural network 222 Hₘₐₚₚₑᵣ. The structure of the symbol mapping neural network 222 Hₘₐₚₚₑᵣ is described in greater detail with reference to FIG. 7. The symbols mapping neural network 222 maps the multiple sets of possible symbols in the possible symbol matrix W^{(τ)} 606 into the coded symbols 110 for transmission to node B 104. The symbols mapping neural network 222 maps the multiple sets of possible symbols to respective coded symbols 110 using softmax encoding.

The code symbols 110 can be transmitted to node B 104 without further processing. However, preferred implementations also provide at least one, or both, of power normalisation and power reallocation as described above.

Referring to FIG. 7, there is shown a view 700 of an example of the functional elements of each of the feature extractor neural network 220, the sequence to sequence neural network 604 and the symbol mapping neural network 222.

In the example depicted in FIG. 7, the features extractor neural network comprises a number of linear layers 702 to 706 and a number of activation layers 708 to 710. Examples are realised in which there are bs or q instances of the feature extractor neural network; each instance is arranged to process a respective feature matrix. Therefore, in training, bs instances of training are performed in parallel, that is, there are bs instances of Q^{(τ)} in one training.

In the example shown, the linear layers 702 to 706 are fully connected linear layers and the activation layers 708 to 710 use GeLu activation functions. Although the example illustrated in FIG. 7 uses GeLu activation functions, examples can be realised in which other activation functions are used such as, for example, the above-described ReLu activation functions. Furthermore, although the example shown in FIG. 7 uses three linear layers 702 to 706 and two activation layers 708 to 710 disposed in between the linear layers 702 to 706, examples are not limited to such an arrangement of layers, or to such a number of linear layers or such a number of activation layers.

In the example shown in FIG. 7, a first linear layer 702 has dimensions 19×64. Although the first layer 702 has 64 output nodes, examples are not limited to such an arrangement. Examples can be realised in which some other number of output nodes is used to achieve a desired balance between accurate modulation and demodulation of data and processing power required for at least one of training and implementation. It will be appreciated that the notion [symbol] ^{bs} is an indication of the number of instances of H_{extractor} that are arranged in parallel.

There are bs instances of the feature extractor neural network 220. The output 712 of the, or of each instance of the, first linear layer 702 is a matrix or tensor having dimensions [symbol] ^{bs×17×64}. Each of the matrices of dimension [symbol] ^{bs×17×64} is fed into respective instances of the first activation layer 708. Each of the inputs to the activation layer is passed through a respective activation function. In the example depicted, the activation function is a GeLu activation function. The first activation layer 708 comprises l, where l=17 in the present example, GeLu activation functions. The output 714 of the first activation layer 708 is a matrix or tensor having dimensions [symbol] ^{bs×17×64} that is, bs instances of 2D matrices of dimension [symbol] ^{17×64}.

The output 714 matrix is input into a second linear layer 704. The second linear layer comprises a 64×64 neural network that produces an output matrix 716 having dimensions [symbol] ^{bs×17×64}. The output matrix 716 is fed into the second activation layer 710, where each input is subjected to a GeLu activation function. The output 718 of the second activation layer 710 is also a matrix of dimensions [symbol] ^{bs×17×64}.

The output 718 of the second activation layer 710 is input into the third linear layer 706. The third linear layer comprises a 64×32 neural network that produces an output matrix 720 having dimensions [symbol] ^{bs×17×32}. The output matrix 720 corresponds to the above-described extracted features matrix V^{(τ)}∈ [symbol] ^{bs×17×32}.

Still referring to FIG. 7, there is shown an instance or example of the sequence to sequence neural network Hₛ₂ₛ 604. The sequence to sequence neural network 604 comprises multiple encoding blocks 722 to 724. In the example depicted in FIG. 7, two encoding blocks 722 and 724 are illustrated. The encoding blocks are realised as neural networks and are examples of the above-described encoding blocks 202. A first encoding block 722 takes the extracted features matrix V^{(τ)} 602 as an input and produces an output matrix 726 having dimensions [symbol] ^{bs×17×32}. The output matrix 726 is fed as an input into the second encoding block 724. The second encoding block produces an output matrix 728 having dimensions [symbol] _{bs×17×32}. The output matrix 728 corresponds to the above-described possible symbols matrix WM 606.

The possible symbols matrix W^{(τ)} 606 is fed to the symbols mapper neural network 222. The symbols mapper neural network 222 comprises a linear layer neural network 730. The linear layer neural network 730 has dimensions 32×2 and produces an output matrix 732 of coded symbols. The matrix 732 corresponds to the above-described matrix of coded symbols 110.

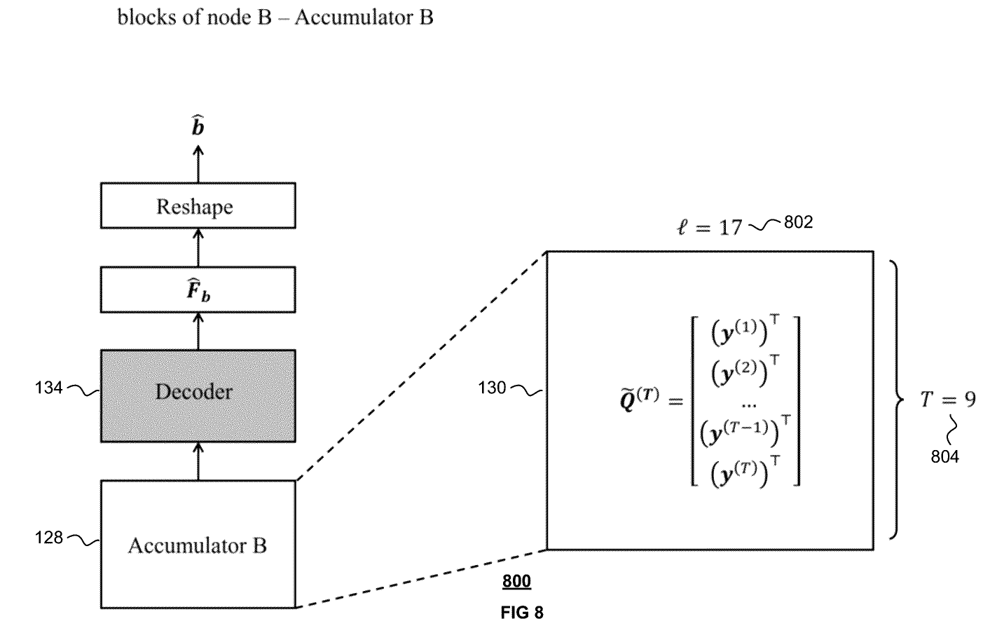

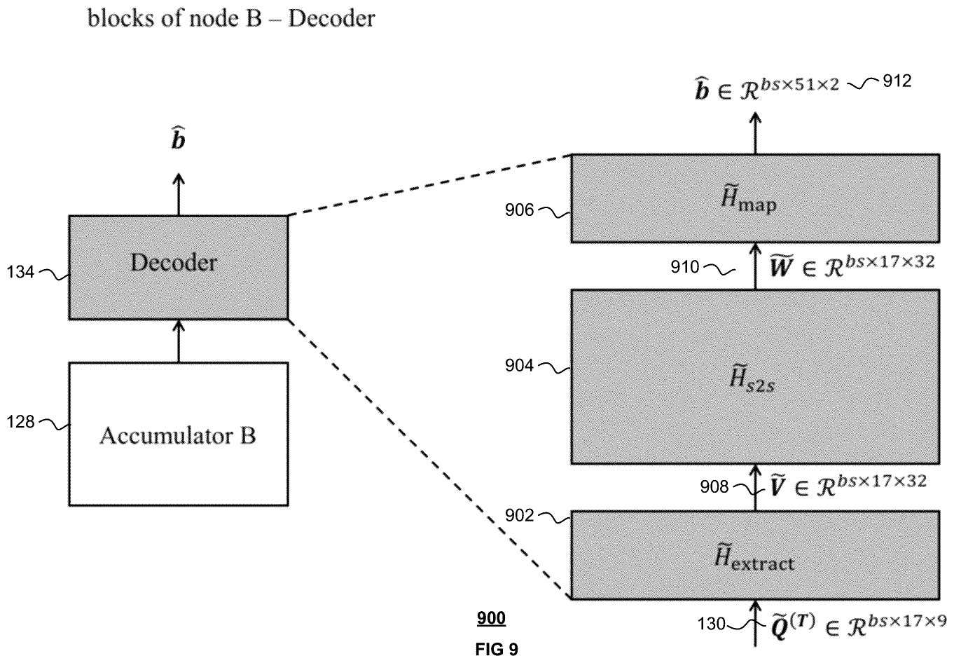

Referring to FIG. 8, there is shown a view 800 of the processing and output performed by the accumulator 128 at node B 104. The accumulator 128 is arranged to generate the above-described knowledge matrix Q^{(τ)} 130. Again, the above-described assumptions prevail, that is, K=51, N=153, m=3, l=┌K/m┐, q=l=17, T=┌N/q┐=9 and that Disentanglement applies. Therefore, it can be appreciated that the knowledge matrix \tilde{Q}^{(τ)} 130 has dimensions \tilde{Q}^{(τ)}∈R^{bs×l×T}. The knowledge matrix is given by

$${\tilde{Q}}^{( T )} = [ \begin{matrix}{( {y}^{( 1 )} )}^{⊤} \\ {( {y}^{( 2 )} )}^{⊤} \\ … \\ {( {y}^{( T ‐ 1 )} )}^{⊤} \\ {( {y}^{( T )} )}^{⊤}\end{matrix} ] .$$

The knowledge matrix \tilde{Q}^{(τ)} 130 is output to the decoder neural network 134.

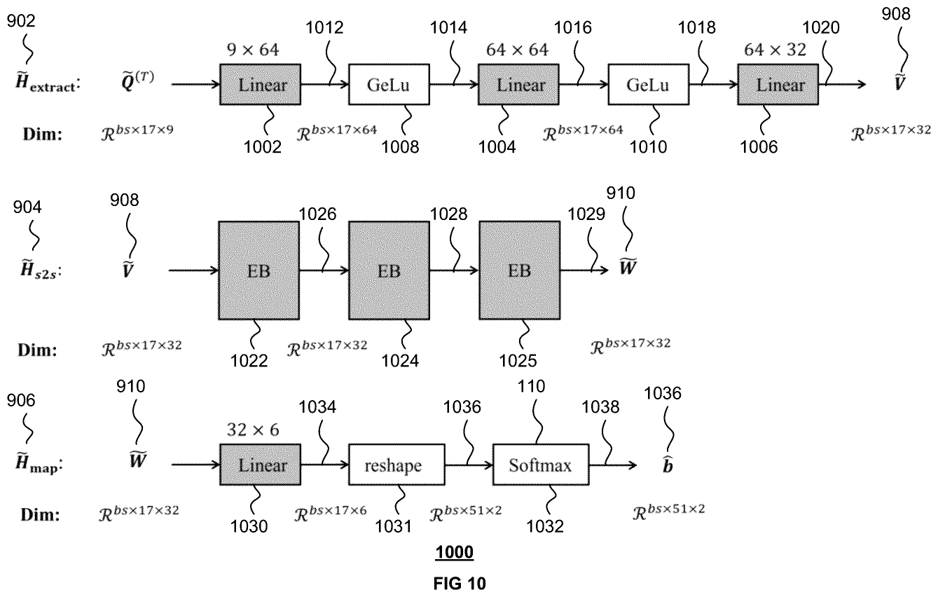

Referring to FIG. 9, there is shown a view 900 of the decoder neural network 134. The decoder neural network 134 is arranged to process the received knowledge matrix \tilde{Q}^{(τ)} 130 having dimensions l=17 802 and T=9 804. The decoder neural network 134 comprises a feature extraction neural network 902, a sequence to sequence neural network 904 and a symbol mapping neural network 906. The structure or architecture of the decoder neural network 134 is identical to the above-described encoder neural network 122. The dimensions of the neural networks are given in FIG. 10.

The feature extraction neural network 902 processed the knowledge matrix \tilde{Q}^{(τ)} 130 to generate an extracted features matrix \tilde{V}∈ [symbol] _{bs×17×19} 908. The extracted features matrix \tilde{V} 908 is processed by the sequence to sequence neural network 904 to produce a candidate symbol matrix \tilde{W}∈ [symbol] ^{bs×17×32} 910. The candidate symbol matrix \tilde{W} 910 comprises a plurality of candidate symbols. The candidate symbol matrix \tilde{W} 910 is processed by the symbol mapping neural network 906 to produce a decoded bitstream vector \hat{b}∈ [symbol] ^{bs×51×2} 912 containing estimates of the initially transmitted bitstream b 103. It will be appreciated that the actual dimension of \hat{b} is \hat{b}∈ [symbol] ^{bs×51×1}. However, since for each bit, a binary distribution (p,p−1) is generated, the output of the neural network 906 is \hat{b}∈ [symbol] ^{bs×51×2} from which \hat{b}∈ [symbol] ^{bs×51×1} is decoded.

Returning to FIG. 8, it can be seen that the output of the decoder 134 can be reshaped to give the estimated bitstream \hat{b} 912.

Referring to FIG. 10, there is shown a view 1000 of an example of the functional elements of each of the feature extractor neural network 902, the sequence to sequence neural network 904 and the symbol mapping neural network 906.

In the example depicted in FIG. 10, the features extractor neural network 902 comprises a number of linear layers 1002 to 1006 and a number of activation layers 1008 to 1010. Examples are realised in which there are bs instances of the feature extractor neural network; each instances is arranged to process a respective feature matrix.

In the example shown, the linear layers 1002 to 1006 are fully connected linear layers and the activation layers 1008 to 1010 use GeLu activation functions. Although the example illustrated in FIG. 10 uses GeLu activation functions, examples can be realised in which other activation functions are used such as, for example, the above-described ReLu activation functions. Furthermore, although the example shown in FIG. 10 uses three linear layers 1002 to 1006 and two activation layers 1008 to 1010 disposed in between the linear layers 1002 to 1006, examples are not limited to such an arrangement of layers, or to such a number of linear layers or such a number of activation layers.

In the example shown in FIG. 10, a first linear layer 1002 is a neural network that has dimensions 9×64. There are bs instances of the feature extractor neural network 902. The output 1012 of the, or of each instance of the, first linear layer 1002 is a matrix having dimensions [symbol] ^{bs×17×64}. That matrix having dimensions [symbol] ^{bs×17×64} is fed into the first activation layer 1008. The first activation layer 1008 comprises l, where l=17 in the present example, GeLu activation functions. The output 1014 of the first activation layer 1008 is a matrix having dimensions [symbol] ^{bs×17×64}.

The output 1014 matrix having dimensions [symbol] ^{bs×17×64} is input into a second neural network linear layer 1004. The second linear layer comprises a 64×64 neural network that produces an output matrix 1016 having dimensions [symbol] ^{bs×17×64}. The output matrix 1016 is fed into the second activation layer 1010, where each input is subjected to a GeLu activation function. The output 1018 of the second activation layer 1010 is also a matrix of dimensions [symbol] ^{bs×17×64}.

The output 1018 of the second activation layer 1010 is input into the third linear layer 1006. The third linear layer comprises a 64×32 neural network that produces an output matrix 1020 having dimensions [symbol] ^{bs×17×32}. The output matrix 1020 corresponds to the above-described extracted features matrix \tilde{V}^{(τ)}∈ [symbol] ^{bs×17×32} 908.

Still referring to FIG. 10, there is shown an instance or example of the sequence to sequence neural network \tilde{H}ₛ₂ₛ 904. The sequence to sequence neural network 904 comprises multiple encoding blocks 1022 to 1025. In the example depicted in FIG. 10, three encoding blocks are illustrated. The encoding blocks are realised as neural networks and are examples of the above-described encoding blocks 202. A first encoding block 1022 takes the extracted features matrix \tilde{V}^{(τ)} 908 as an input and produces an output matrix 1026 having dimensions [symbol] ^{bs×17×32}. The output matrix 1026 is fed as an input into the second encoding block 1024. The second encoding block produces an output matrix 1028 having dimensions [symbol] ^{bs×17×32}. The output matrix 1028 is fed as an input into the third encoding block neural network 1025 and produces an output matrix 1029 having dimensions [symbol] ^{bs×17×32}. The output matrix 1029 corresponds to the above-described possible symbols matrix \tilde{W}^{(τ)} 910.

The possible symbols matrix W(τ) 910 is fed to the symbols mapper neural network 906. The symbols mapper neural network 906 comprises a linear layer neural network 1030, a reshape function 1031 and a softmax function 1032. The linear layer neural network 1030 has dimensions 32×6 and produces an output matrix 1034 of coded symbols having dimensions [symbol] ^{bs×17×6}. The reshaping function 1031 processes the output matrix 1034 to produce a reshaped matrix. The reshaped matrix comprises a rearrangement of the values of the output matrix 1034 to produce an output matrix 1036 of candidate decoded symbols. The output matrix 1026 has dimensions [symbol] ^{bs×51×2}. Each instance of the output matrix 1034 of the possible decoded symbols two values is processed by the softmax function 1032 to generate a matrix 1038 of decoded symbols. The matrix 1038 corresponds to the above-described matrix of decoded symbols 912.

It can be appreciated from the above that the neural-encoder at node A 102 performs simultaneously two tasks; namely, keeping track of a current belief regarding the original bits at the receiver and generating symbols accordingly in order to refine the belief. It can be appreciated that the above-described GBAF uses a single network for both tasks.

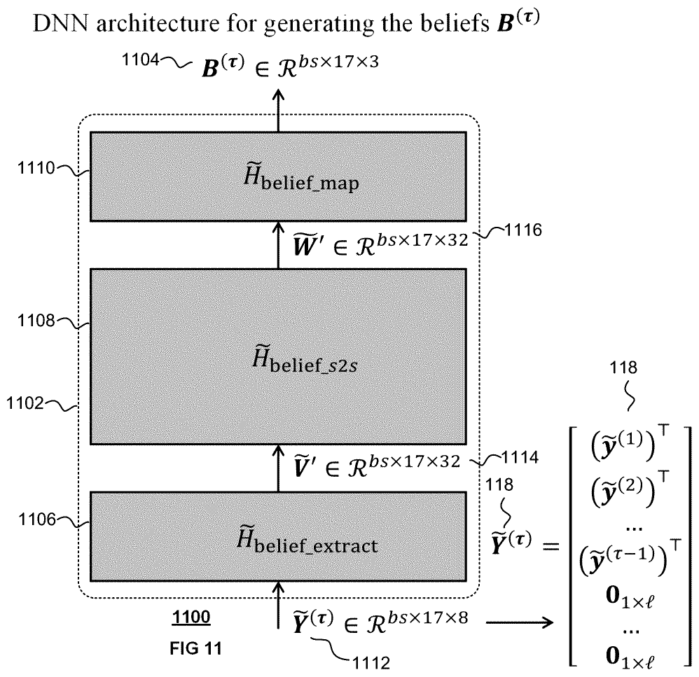

Referring again to FIG. 1, it can be seen that there is disclosed a belief network. The structure and function of the belief network will be described with reference to FIG. 11. Providing a belief network increases the information processing capacity of the network layer by adding additional self-attention layers with the specific task of keeping track of the current belief at the receiver. An architecture that uses belief feedback is known as a GBAF with belief feedback.

It will be appreciated from the above GBAF that the feedback information (parity symbols and combined noise values) and the original bitstream (modulated or unmodulated) are processed simultaneously. However, examples using belief feedback support learning the residual error between the original bits of the bitstream and the prediction at node B 104 based on symbols received so far. Therefore, examples can be realised that add another deep neural network for generating a belief vector on the original bitstream based on the feedback information comprising the parity symbols and the combined noise values. The belief vector can be concatenated with the vector of the original unmodulated bitstream 103 and conveyed to the encoder as part of the information vector or knowledge vector Q^{(τ)} 126

Referring to FIG. 11, there is shown a view 1100 of a belief network 1102 according to examples. The deep neural network architecture used for generating beliefs is identical to the one used for generating parity symbols. Any of the examples described herein can be realised with or without a belief network 1102. The belief deep neural network 1102 is a neural network for generating a matrix of beliefs B^{(τ)}∈ [symbol] ^{bs×17×32} 1104. The belief neural network 1102 comprises three main parts; namely, a feature extractor neural network 1106, a belief sequence to sequence neural network 1108 and a belief mapping neural network 1110.

The feature extractor neural network 1106 has an input matrix \tilde{Y}^{(τ)}∈ [symbol] ^{bs×17×8} 1112, that is, \tilde{Y}^{(τ)}∈ [symbol] i.e. the totality of all feedback from node B 104, that is, all received feedback signals comprising feedback symbols and noise, where

$${\tilde{Y}}^{( τ )} = [ \begin{matrix}{( {\tilde{y}}^{( 1 )} )}^{⊤} \\ {( {\tilde{y}}^{( 1 )} )}^{⊤} \\ \begin{matrix}… \\ {( {\tilde{y}}^{( τ ‐ 1 )} )}^{⊤} \\ {0}_{1 xl} \\ …\end{matrix} \\ {0}_{1 xl}\end{matrix} ] .$$

The feature extractor neural network 1106 processed the input matrix \tilde{Y}^{(τ)} 1112 to produce a feature matrix \tilde{V}′∈ [symbol] ^{b×17×32} 1114. The feature matrix \tilde{V}′ 1114 is input into the belief sequence to sequence neural network 1108. The belief sequence to sequence neural network 1108 processes the feature matrix \tilde{V}′1114 to produce a matrix of candidate beliefs \tilde{W}′∈ [symbol] ^{bs×17×32} 1116. The matrix of candidate beliefs \tilde{W}′ 1116 forms an input to the belief mapping neural network 1110. The belief mapping neural network 1110 processes the matrix of candidate beliefs \tilde{W}′ 1116 to form the matrix of beliefs B^{(τ)}∈ [symbol] ^{bs×17×32} 1104. The architecture for the belief neural network 1102 is almost identical to the architecture for the encoder 122 described above with the exception that the belief mapping neural network 1110 uses an extra softmax layer to generate the beliefs in the form of output probabilities.

The matrix of beliefs B^{(τ)}∈ [symbol] ^{bs×17×32} 1104 is fed to the accumulator 124 of node A 102 to form part of, or be used with, the information vector or knowledge vector Q^{(τ)} 126, in particular, pre-processing of the knowledge vector is given by

Sₑ(Q^{(τ)},B^{(τ)})={Qᵢ^{(r)}, . . . , Qₗ^{(r)}}. The overall architecture for feedback encoding and decoding incorporating beliefs is known as Unified Iterative Parity Symbol Encoding (UIPSE) and is shown below in detail in Algorithm 3.

Algorithm 3 Unified Iterative parity symbol encoding (UIPSE)

| | |
|---|---|
| 1: | for τ = 1, . . . , T do |
| 2: | Update Knowledge vector: |
| 3: | Q^{(τ)} = [b, c⁽¹⁾, . . . , c^{(τ-1)}, \tilde{y}⁽¹⁾, . . . , \tilde{y}^{(τ-1)}] |
| 4: | if Belief feedback is enabled then |
| 5: | Pre-process knowledge vector for belief network: |
| 6: | S_{b}(Q^{(τ)}) = {\tilde{Q}ᵢ^{(τ)}, . . . , \tilde{Q}ᵢ^{(τ)}}, such that: |
| 7: | \tilde{Q}ᵢ^{(τ)} = [\tilde{y}ᵢ⁽¹⁾, . . . , \tilde{y}ᵢ^{(τ-1)}] |
| 8: | Extract features: Vᵢ^{(τ)} = H_{extract}^{belief}(\tilde{Q}ᵢ^{(τ)}) |
| 9: | Attention-based neural-encoding:\tilde{V}_{belief}^{(τ)} = H [symbol] ^{belief} (V_{belief}^{(τ)}) |
| 10: | Generate Belief Feedback: B [symbol] ^{(τ)} = Hₘₐₚ^{belief} (\tilde{V}ᵢ^{(τ)}) |
| 11: | Pre-process Knowledge vector: |
| 12: | S [symbol] (Q^{(τ)}, B^{(τ)}) = {Qᵢ^{(τ)}, . . . , Qᵢ^{(τ)}}, such the: |
| 13: | if Feedback-only is True then |
| 14: | Qᵢ^{(τ)} = [b_{((i-1)m+1:im)}, Bᵢ^{(τ)}, \tilde{y}ᵢ⁽¹⁾, . . . , \tilde{y}ᵢ^{(τ-1)}] |
| 15: | else if Noise-only is True then |
| 16: | Qᵢ^{(τ)} = [b_{((i-1)m+1:im)}, Bᵢ^{(τ)}, \tilde{y}ᵢ⁽¹⁾ − cᵢ⁽¹⁾, . . . , \tilde{y}ᵢ^{(τ-1)} − cᵢ^{(τ-1)}] |
| 17: | else if Disentangle is True then |
| 18: | Qᵢ^{(τ)} = [b_{((i-1)m+1:im)}, Bᵢ^{(τ)}, cᵢ⁽¹⁾, . . . , cᵢ^{(τ-1)}, \tilde{y}ᵢ⁽¹⁾ − cᵢ⁽¹⁾, . . . , \tilde{y}ᵢ^{(τ-1)} − |
| | cᵢ^{(τ-1)}] |
| 19: | else |
| 20: | Qᵢ^{(τ)} = [b_{((i-1)m+1:im)}, Bᵢ^{(τ)}, cᵢ⁽¹⁾, . . . , cᵢ^{(τ-1)}, \tilde{y}ᵢ⁽¹⁾, . . . , \tilde{y}ᵢ^{(τ-1)}] |
| 21: | Feature extraction: |
| 22: | for i ϵ [l] do |
| 23: | Vᵢ^{(τ)} = H_{extract}(Qᵢ^{(τ)}) |
| 24: | Attention-based Neural-encoding V^{(τ)} = H_{encoder} (\tilde{V}^{(τ)}) |
| 25: | Symbol mapping: |
| 26: | for i ϵ [l] do |
| 27: | cᵢ^{(τ)} = Hₘₐₚ(\tilde{V}ᵢ^{(τ)}) |
| 28: | else |
| 29: | Run IPSE algorithm |

[symbol]

indicates data missing or illegible when filed

Again, it can be appreciated that a for loop for τ=1, . . . , T is established, that is, a parity symbol is generated per block at each pass. The knowledge vector Q^{(τ)} 126 is updated at line 3 as Q^{(τ)}=[b, c⁽¹⁾ . . . , c^{(τ-1)}, \tilde{y}⁽¹⁾, . . . , y^{(τ-1)}]. A determination is made at line 4 whether or not belief feedback is enabled. If belief processing is not enabled, processing continues at line 29, where Algorithm 2 is implemented. If belief feedback is enabled, processing continues with lines 5 to 27 as follows. At line 6, the knowledge vector Q^{(τ)} 126 vector is established for the belief network as S_{b}(Q^{(τ)})={\tilde{Q}ᵢ^{(τ)}, . . . , \tilde{Q}ₗ^{(τ)}} such that \tilde{Q}ᵢ^{(τ)}=[\tilde{y}ᵢ^{(τ)}, . . . , \tilde{y}ᵢ^{(τ-1)}]. The features of the input vector 1112 are extracted at line 8 by Vᵢ^{(τ)}=H_{extract}^{belief}(\tilde{Q}ᵢ^{(τ)}). Attention-based neural encoding, that is, sequence to sequence encoding, is realised at line 9 using

\tilde{V}_{belief}^{(τ)}=H_{encoder}^{belief}(V_{belief}^{(τ)}). The belief feedback is generated at line 10 using Bᵢ^{(τ)}=Hₘₐₚ^{belief}(\tilde{V}ᵢ^{(τ)}). The information vector or knowledge vector Q^{(τ)} 126 is pre-processed at line 12 such that Sₑ(Q^{(τ)}, B^{(τ)})={Qᵢ^{(τ)}, . . . , Qₗ^{(τ)}}, where Qᵢ^{(τ)} is established according to one of the following conditions: feedback only, noise only, disentanglement or beliefs, symbols and feedback. If feedback only is selected, Qᵢ^{(τ)} is given by

Qᵢ^{(τ)}=[b_{((i-1)*m+1:i*m)}, Bᵢ^{(τ)}, \tilde{y}ᵢ⁽¹⁾, . . . , \tilde{y}ᵢ^{(τ-1)}]. If noise only is selected, Qᵢ^{(τ)} is given by Qᵢ^{(τ)}=[b_{((i-1)*m+1:i*m)}, Bᵢ^{(τ)}, \tilde{y}ᵢ^{(1)-c}ᵢ⁽¹⁾, . . . , \tilde{y}ᵢ^{(τ-1)}−cᵢ^{(τ-1)}]. If Disentanglement is enabled, Qᵢ^{(τ)} is given by Qᵢ^{(τ)}=[b_{((i-1)*m+1:i*m)}, Bᵢ^{(τ)}, cᵢ⁽¹⁾, . . . , cᵢ^{(τ-1)}, \tilde{y}ᵢ⁽¹⁾−cᵢ⁽¹⁾, . . . , \tilde{y}ᵢ^{(τ-1)}−cᵢ^{(τ-1)}]. Otherwise Qᵢ^{(τ)} is given by Qᵢ^{(τ)}=[b_{((i-1)*m+1:i*m}, Bᵢ^{(τ)}, cᵢ⁽¹⁾, . . . , cᵢ^{(τ-1)}, \tilde{y}ᵢ⁽¹⁾, . . . , \tilde{y}ᵢ^{(τ- 1)}]. Feature extraction is then performed at lines 22 and 23 for all l blocks by establishing a for loop as for i∈[l]do,Vᵢ^{(τ)}=H_{extract}(Qᵢ^{(τ)}), followed by Attention-based Neural-encoding at line 24 given by V^{(τ)}=H_{encoder}(\tilde{V}^{(τ)}). Finally, symbol mapping is performed at lines 26 and 27 via for i∈[l]do,cᵢ^{(τ)}=Hₘₐₚ(\tilde{V}ᵢ^{(τ)}).

Referring again to FIG. 1, a unified architecture for feedback encoding is presented including all features identified using dashed lines, which are options in the most basic examples of feedback encoding.

The unified architecture of FIG. 1 comprises a plurality of feedback mechanisms; namely inner feedback, outer feedback, and belief feedback.

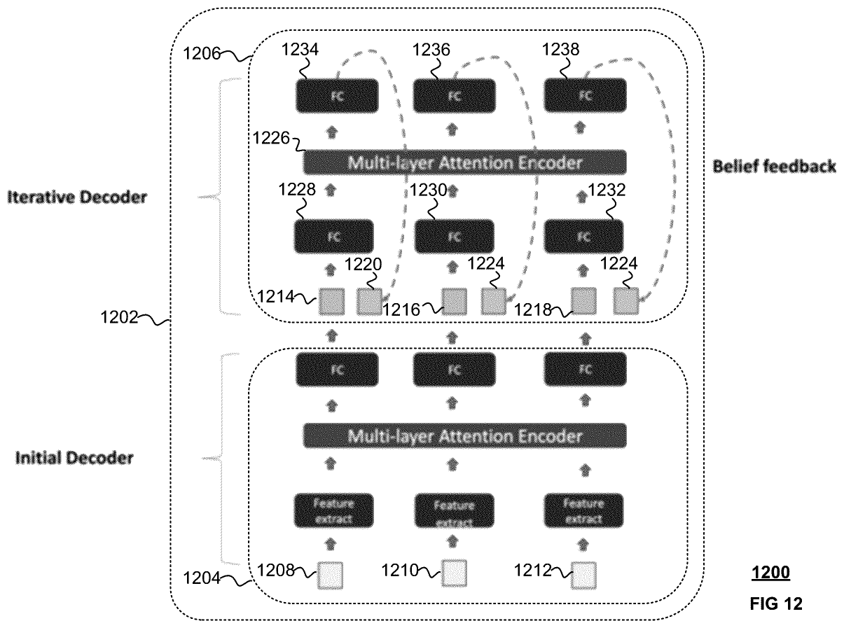

Inner feedback refers to the process of using generated parity symbols as inputs to the encoder 122 at consecutive iterations as will be described with reference to FIG. 12 hereafter. The objective of inner feedback is to enable the encoder to recall or use previously transmitter symbols.

Outer feedback refers to the feedback channel information received at node A 102 from node B 104, which enables the encoder to track noise realisations.

Belief feedback is the output of the additional deep neural network employed at node A 102 that is used to track node B's belief about the bitstream after each transmission block.

It will be appreciated that enabling and disabling the belief feedback supports switching between variations of GBAF and GBAF-BF. Still further, examples can be realised that disable or enable the inner or outer feedback mechanisms as well, which supports realising different variations of the unified GBAF. Therefore, examples can be realised in which the encoder comprises a selectable plurality of feedback mechanisms to support feedback encoding of a bitstream, the selectable plurality of feedback mechanisms comprising at least one of the following, taken jointly and severally in any and all permutations: inner feedback comprising processing generated parity symbols as inputs to the encoder, outer feedback comprising processing feedback channel to determine noise associated with at least one, or both, of a feedforward channel and a feedback channel, and belief feedback comprising data associated with the bitstream at a receiver after each transmission block.

Referring to FIG. 12, there is shown a view 1200 of an iterative decoder 1202 for feedback encoding and decoding. The decoder 1202 comprises an initial decoding module 1204 and an iterative decoding module 1206. The initial decoding module 1204 is invoked once to map received parity symbols 1208 to 1212 for each block to a latent representation 1214 to 1218.

The iterative decoding module 1206 is invoked multiple times and is arranged to use previous decoding outputs 1220 to 1224 as inputs to the iterative decoding process by concatenating the latent representations 1214 to 1218 and the previous decoding outputs 1220 to 1224. The iterative decoding process forms a belief propagation mechanism through a multi-layer attention encoder 1226. The iterative decoding module 1206 comprises multiple fully connected layers. In the example depicted in FIG. 12, the multiple fully connected layers comprise a number of input fully connected layers 1228 to 1232, and a number of fully connected output layers 1234 to 1338.

It will be appreciated that the iterative decoding module 1206 uses the output of the output fully connected layers 1234 to 1238 as beliefs to refine predictions in a manner similar to recurrent neural network architectures. The fully connected layers 1228 to 1238 are arranged to align the sizes of the latent representations 1214 to 1218.

In the example described, there are two layers, that is, there are two encoders. However, examples are not limited to two such layers. Examples can be used in which two or more than two such layers are used. Furthermore, the iterative decoding module 1206 can be invoked multiple times. Examples can be realised in which the iterative decoding module 1206 can be invoked three times. However, examples are not limited to the iterative decoding layer 1206 being involved three times. Examples can be realised in which the iterative decoding layer 1206 is involved two or more times. Accordingly, examples can be realised in which the iterative decoding module 1206 comprises a plurality of fully connected layers and a multi-layer attention encoder 1226 that are invoked two or more times.

It will be appreciated from FIGS. 7 and 10 that the encoder and decoders use different numbers of encoding blocks or encoding layers. In the examples described, the encoder comprises two encoding blocks or layers and the decoder comprises three encoding blocks or layers. Accordingly, examples can be realised in which the encoder comprises a respective number encoder encoding blocks or layers and the decoder comprises a respective number of decoder encoding blocks or layers. The respective number encoder encoding blocks or layers and the respective number of decoder encoding blocks or layers can be the same or different. Examples can be realised in which the number of encoder encoding blocks is greater than the number of decoder encoding blocks or layers. Alternatively, examples can be realised in which the number of encoder encoding blocks is less than the number of decoder encoding blocks or layers.

In training the neural networks of the examples, an AdamW optimizer was utilised, which is a variation of the Adam optimizer but with decoupled weight decay regularization. Also, a batch size of B=8192 was used, with an initial learning rate of 0.001 and a weight decay parameter of 0.01. Furthermore, gradient clipping was applied with a threshold of 0.5 and the neural networks were trained for 600,000 batches together with applying polynomial decay to the learning rate.

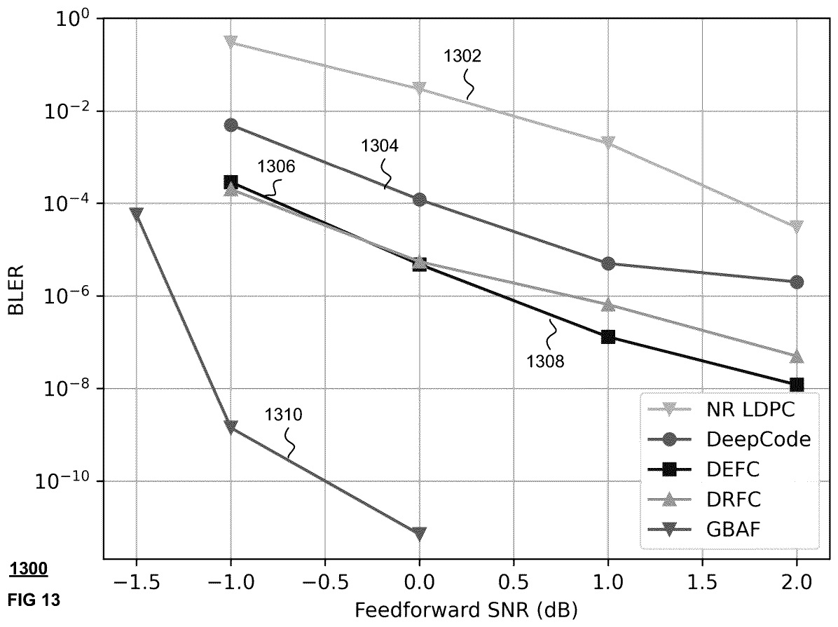

Referring to FIG. 13, there is shown a view 1300 of BLER versus Feedforward SNR (dB) performance graphs of the examples described here compared to existing coding strategies for the same coding rate, where K=51, N=153, m=3.

The view 1300 shows:

a BLER performance curve 1302 for 5G NR LDPC, that is, a 5G New Radio Low-Density Parity-Check code,

a BLER performance curve 1304 for Deepcode as described in “Deepcode: Feeback Codes via Deep Learning” by Hyeji Kim, Yihan Jiang, Sreeram Kannan, Sewoong Oh, Pramod Viswanath, available from https://arxiv.org/pdf/1807.00801v1.pdf,

a BLER performance curve 1306 for Deep Extended Feedback Codes, as described in https://arxiv.org/pdf/2105.01365.pdf, Anahid Robert Safavi, Alberto G. Perotti, Branislav M. Popovi\tilde{c}, Mandi Boloursaz Mashhadi, Deniz Gündüz,

a BLER performance curve 1308 for DRFC coding, and

a BLER performance curve 1310 according to GBAF coding as described herein.

It can be appreciated that the performance of GBAF is significantly better than the above prior art feedback coding techniques.

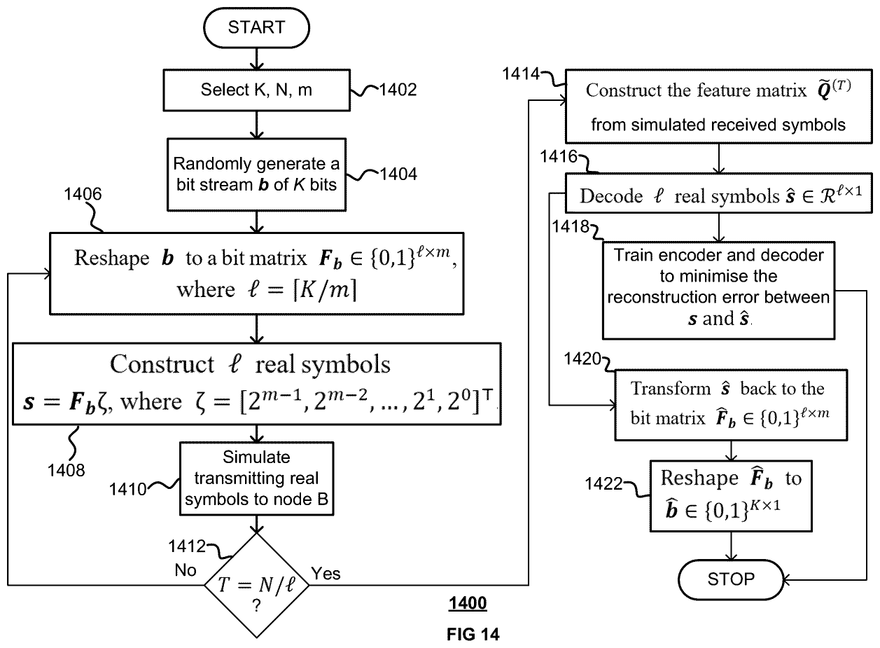

Referring to FIG. 14, there is shown a view 1400 of a flowchart for generating training data for training the neural networks of the examples described herein.

At 1402, the parameters K, N, m are selected, where K represents the number of bits in the bitstream 103, N represents the total number of bits to be transmitted and m represents the number of bits per block.

At 1404, a bitstream b 103 of K bits is generated; the K bits comprise randomly generated bits. The bitstream is reshaped, at 1406, to produce a bit matrix F_{b}∈ [symbol] , where [symbol] =┌K/m┐.

At 1408, [symbol] real symbols s=F_{b}ζ, where ζ=[2^{m-1}, 2^{m-2}, . . . , 2¹, 2⁰]^{T} are constructed for “transmission” to node B. The word “transmission” is in quotes since the channel and transmission are simulated such that actual transmission does not take place when generating the training data and using that data to train neural networks. Therefore, it will be appreciated that “transmission” within this training context means subjecting the bit matrix to a transfer function representing the channel conditions of a given channel to produce transmitted/received symbols.

Generating the bitstream 103 at 1406 and constructing the [symbol] real symbols at 1408 is repeated a predetermined number of times, that is, a predetermined number of interactions take place. Examples can be realised in which the predetermined number of times is governed by T=N/ [symbol] interactions. Accordingly, at 1412, a determination is made regarding the number of interactions that have taken place thus far. If the determination at 1412 is that T=N/ [symbol] or fewer interactions have taken place, processing resumes at 1406 where a new bitstream is generated. If more than T=N/ [symbol] interactions have taken place, processing proceeds to 1414, where the feature matrix \tilde{Q}^{(τ)} is constructed and, at 1416, [symbol] real symbols ŝ∈ [symbol] are decoded.

Once the [symbol] real symbols ŝ∈ [symbol] have been decoded, the above-described encoders and decoders, that is, the above described neural networks, are trained, at 1418, to minimise the error between s and ŝ.

Alternatively, during actual encoding and decoding, that is, during actual feedback encoding and decoding once the neural networks have been trained, following decoding of the [symbol] real symbols ŝ∈ [symbol] at 1416, the estimated or decoded symbols ŝ are transformed into a corresponding bit matrix \hat{F}_{b}∈ [symbol] at 1420, and, at 1422, the bit matrix \hat{F}_{b} is reshaped to give a decoded or demodulated bitstream to \hat{b}∈{0,1}^{K×1}.

Referring to FIG. 15, there is shown a view 1500 of a flowchart for Algorithm 2. At 1502, a for loop is established to step through all blocks of data to be transmitted. The for loop is for τ=2, . . . , T. At 1504, the information vector or knowledge vector Q^{(τ)} 126 is established or updated to give Q^{(τ)}=[b, c⁽¹⁾, . . . , c^{(τ-1)}, \tilde{y}⁽¹⁾, . . . , \tilde{y}^{(τ-1)}]. At 1506, the knowledge vector Q^{(τ)} 126 is pre-processed to generate Sₑ(Q^{(τ)})={Q₁^{(τ)}, . . . , Qₗ^{(τ)}} where Qᵢ^{(τ)} is selected according to which prevailing mode of operation has been selected. Examples can provide a number of modes of operations including the following: Feedback only mode, noise only mode, disentanglement mode or hybrid mode. A determination is made at 1508 if the current mode is the feedback only mode. If the determination is positive, Qᵢ^{(τ)} is established as Qᵢ^{(τ)}=[b_{((i-1*m}_{₁}_{:i*m)}, \tilde{y}ᵢ⁽¹⁾, . . . , \tilde{y}ᵢ^{(τ-1)}] at 1510. If the determination is negative, a determination is made 1512 if the current or selected mode is the noise only mode. If the determination at 1512 is positive, Qᵢ^{(τ)} is established as Qᵢ^{(τ)}=[b_{((i-1)*m}_{₁}_{:i*m)}, \tilde{y}ᵢ⁽¹⁾−cᵢ⁽¹⁾, . . . , \tilde{y}ᵢ^{(τ-1)}−cᵢ^{(τ-1)}] at 1514. If the determination at 1512 is negative, a determination is made at 1516 if the current or selected mode is disentanglement mode. If the determination at 1516 is positive, Qᵢ^{(τ)} is established as Qᵢ^{(τ)}=[b_{((i-1)*m}_{₁}_{:i*m)}, cᵢ⁽¹⁾, . . . , cᵢ^{(τ-1)}, \tilde{y}ᵢ⁽¹⁾−cᵢ⁽¹⁾, . . . , \tilde{y}ᵢ^{(τ-1)}−cᵢ^{(τ-1)} at 1518. If the determination at 1516 is negative, Qᵢ^{(τ)} is established as Qᵢ^{(τ)}=[b_{((i-1)*m}_{₁}_{:i*m)}, cᵢ⁽¹⁾, . . . , cᵢ^{(τ-1)}, \tilde{y}ᵢ⁽¹⁾−cᵢ⁽¹⁾, . . . , \tilde{y}ᵢ^{(τ-1)}−cᵢ^{(τ-1)} at 1520. Having established Qᵢ^{(τ)} and, therefore, Sₑ(Q^{(τ)})={Q₁^{(τ)}, . . . , Qₗ^{(τ)}}, processing continues at 1522, where feature extraction is performed by processing all Qᵢ^{(τ)} for all i∈[l] to establish Vᵢ^{(τ)}=H_{extract}(Qᵢ^{(τ)}). At 1524, attention-based neural processing is performed to establish V^{(τ)}=H_{encoder}(\tilde{V}^{(τ)}). Having established V^{(τ)}, the symbols to be transmitted are established at 1526 for all i∈[l] as follows: cᵢ^{(τ)}=Hₘₐₚ(\tilde{V}ᵢ^{(τ)}).

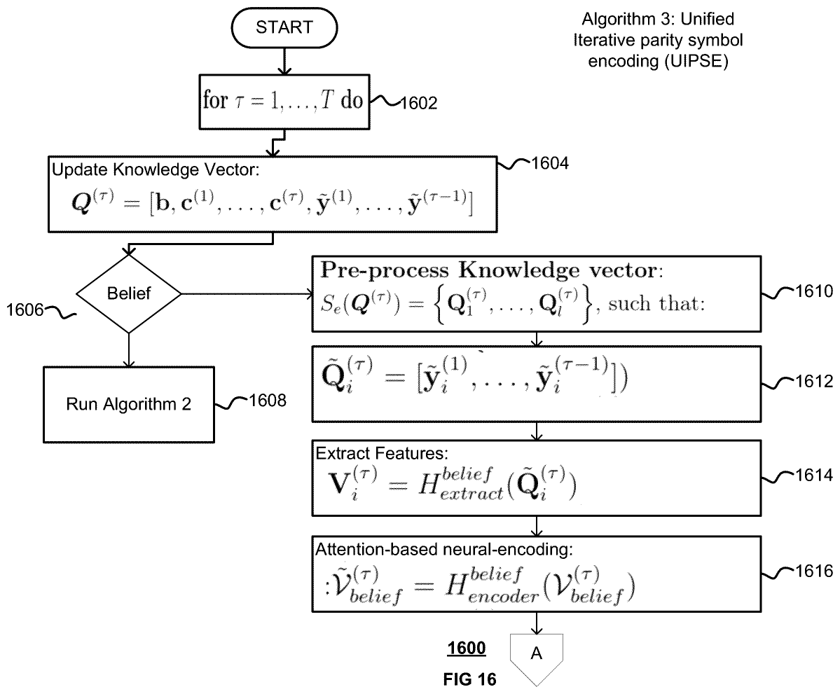

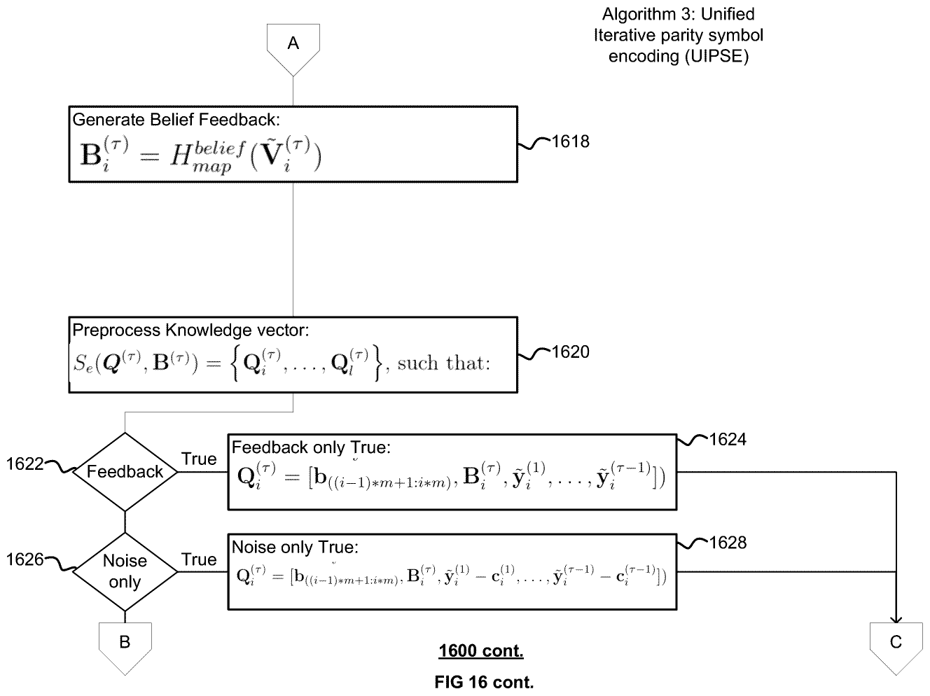

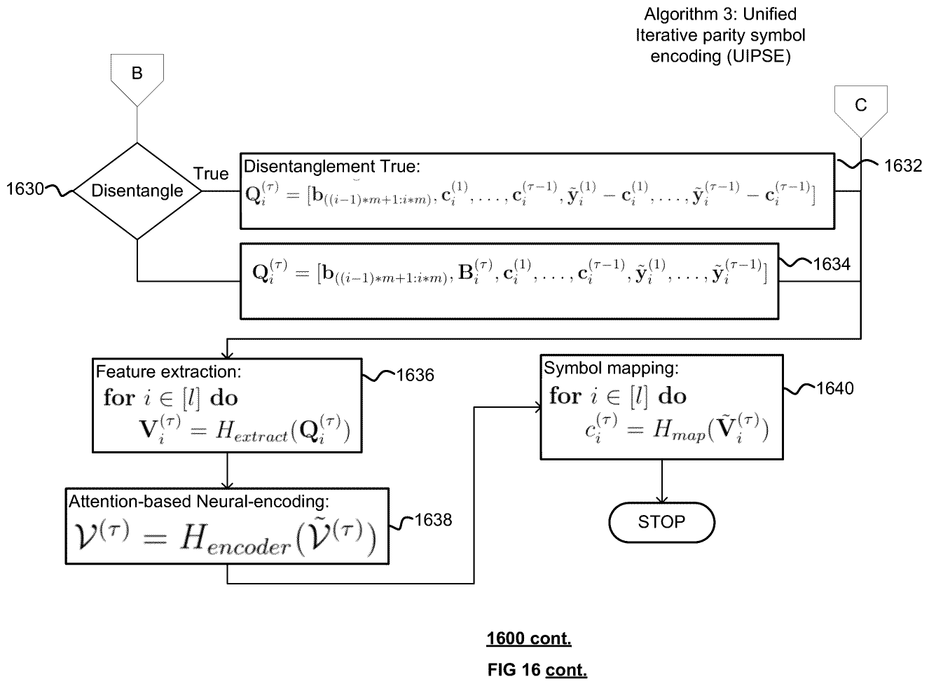

Referring to FIG. 16, there is shown a view 1600 of a flowchart for Algorithm 3 relating to Unified Iterative Parity Symbol Encoding (UIPSE). At 1602, a count is established to step through all blocks to be transmitted as f or τ=1, . . . , T. At 1604, the information vector or knowledge vector Q^{(τ)} 126 is established or updated to give Q^{(τ)}=[b, c⁽¹⁾, . . . , c^{(τ-1)}, \tilde{y}⁽¹⁾, . . . , \tilde{y}^{(τ-1)}]. A determination is made, at 1606, regarding whether or not beliefs will be taken into account in encoding the bitstream b 103. If the determination at 1606 is negative, processing continues at 1608, where algorithm 2 is executed. If the determination at 1606 is positive, pre-processing of the knowledge vector is commenced at 1610 to establish Sₑ(Q^{(τ)})={Q₁^{(τ)}, . . . , Qₗ^{(τ)}} such that, at 1612, \tilde{Q}ᵢ^{(τ)}=[\tilde{y}ᵢ⁽¹⁾, . . . , \tilde{y}ᵢ^{(τ-1)}] is established. At 1614, belief features are extracted from the knowledge vector via Vᵢ^{(τ)}=H_{extract}^{belief}(\tilde{Q}ᵢ^{(τ)}). The extracted beliefs features are subjected to attention-based neural-encoding at 1616 to establish the candidate associated beliefs via \tilde{V}_{belief}^{(τ}=H_{encoder}^{belief}(V_{belief}^{(τ)}). The candidate associated beliefs are processed at 1618 to establish feedback beliefs via Bᵢ^{(τ)}=Hₘₐₚ^{belief}(\tilde{V}ᵢ^{(τ)}). Next, at 1620, the knowledge vector is pre-processed Sₑ(Q^{(τ)}, B^{(τ)})={Qᵢ^{(τ)}, . . . , Qₗ^{(τ)}}, where Qₗ^{(τ)} is established according to one of the following conditions: feedback only, Noise only, Disentanglement or beliefs, symbols and feedback. A determination, at 1622, is made regarding whether or not feedback only mode is selected. If the determination at 1622 is positive, Qᵢ^{(τ)} is established, at 1624, as Qᵢ^{(τ)}=[b_{((i-1)*m+1:i*m)}, Bᵢ^{(τ)}, \tilde{y}ᵢ⁽¹⁾, . . . , \tilde{y}ᵢ^{(τ-1)}]. If the determination at 1622 is negative, a determination is made, at 1626, regarding whether or not the currently selected mode is noise only. If the determination at 1626 is positive, Qᵢ^{(τ)} is established, at 1628, by Qᵢ^{(τ)}=[b_{((i-1)*m+1:i*m)}, Bᵢ^{(τ)}, \tilde{y}ᵢ⁽¹⁾−cᵢ⁽¹⁾, . . . , \tilde{y}ᵢ^{(τ-1)}−cᵢ^{(τ-1)}]. If the determination at 1626 is negative, a determination is made, at 1630 regarding whether or not Disentanglement mode is selected. If the determination at 1630 is positive, that is, Disentanglement is enabled, Qᵢ^{(τ)} is given by Qᵢ^{(τ)}=[b_{((i-1)*m+1:i*m)}, Bᵢ^{(τ)}, \tilde{y}ᵢ⁽¹⁾−cᵢ⁽¹⁾, . . . , \tilde{y}ᵢ^{(τ-1)}−cᵢ^{(τ-1)}] at 1632. If the determination at 1630 is negative, Qᵢ^{(τ)} is established, at 1634, as Qᵢ^{(τ)}=[b_{((i-1)*m+1:i*m)}, Bᵢ^{(τ)}, \tilde{y}ᵢ⁽¹⁾−cᵢ⁽¹⁾, . . . , \tilde{y}ᵢ^{(τ-1)}−cᵢ^{(τ-1)}].

Having established the selected mode of operating and having established the knowledge vector in response, feature extraction is performed at 1636 for all/blocks by establishing a for loop as for i∈[l]do,Vᵢ^{(τ)}=H_{extract}(Qᵢ^{(τ)}), followed by Attention-based Neural-encoding at 1638 given by V^{(τ)}=H_{encoder}(\tilde{V}^{(τ)}). Finally, symbol mapping is performed, at 1640, via for i∈[l]do,cᵢ^{(τ)}=Hₘₐₚ(\tilde{V}ᵢ^{(τ)}).

Examples can be realised in which active feedback is used to generate modulated data. Referring again to FIG. 1, it can be appreciated that node B 104 comprises an encoder 132. The encoder 132 is arranged to generate the feedback symbols \tilde{c}⁽¹⁾, . . . , \tilde{c}^{(τ)} 116 from the information vector \tilde{Q}^{(τ)} 130. Such active feedback is described in Algorithm 4 below and implemented at node B 104.

Algorithm 4 Unified Iterative Feedback symbol encoding (UIPFE)

| | |
|---|---|
| 1: | for τ = 1, . . . , T − 1 do # Generate 1 feedback symbol per block at each pass |
| 2: | if Active feedback is True then |
| 3: | Update Knowledge vector: |
| 4: | \tilde{Q}^{(τ)} = [\tilde{c}⁽¹⁾, . . . , \tilde{c}^{(τ-1)}, y⁽¹⁾, . . . , y^{(τ)}] |
| 5: | Pre-process Knowledge vector: |
| 6: | Sₑ(\tilde{Q}^{(τ)}) = {\tilde{Q}ᵢ^{(τ)}, . . . , \tilde{Q}ᵢ^{(τ)}}, such that: |
| 7: | if Parity only is True then |
| 8: | \tilde{Q}ᵢ^{(τ)} = [yᵢ⁽¹⁾, . . . , yᵢ^{(τ)}] |
| 9: | else |
| 10: | \tilde{Q}ᵢ^{(τ)} = [\tilde{c}ᵢ⁽¹⁾, . . . , \tilde{c}ᵢ^{(τ-1)}, yᵢ⁽¹⁾, . . . , yᵢ^{(τ)}] |
| 11: | Feature extraction: |
| 12: | for i ϵ [l] do |
| 13: | \tilde{V}ᵢ^{(τ)} = \tilde{H}_{extract}^{feedback}(\tilde{Q}ᵢ^{(τ)}) |
| 14: | S25 Neural-encoding: \tilde{W}^{(τ)} = \tilde{H} [symbol] ^{feedback}(\tilde{V}^{(τ)}) |
| 15: | Symbol mapping: |
| 16: | for i ϵ [l] do |
| 17: | \tilde{c}ᵢ^{(τ)} = \tilde{H}ₘₐₚ^{feedback} (\tilde{W}ᵢ^{(τ)}) |
| 18: | else |
| 19: | \tilde{c}^{τ} = ay^{(τ)} |

[symbol]

indicates data missing or illegible when filed

Referring to Algorithm 4, a for loop is established at line 1 so that a feedback symbol per block is generated at each pass.

A determination is made at line 2 regarding whether or not active feedback is enabled. If active feedback is not enabled, processing proceeds from line 19 where the τ^{th} feedback symbol c^{τ} is determined from the received signal. Examples can be realised in which the τ^{th} feedback symbol c^{τ} is determined as a scaled version of the (τ−1)^{th} received signal αy^{(τ-1)}. If active feedback is enabled, the information vector or knowledge vector \tilde{Q}^{(τ)} 130 is updated at line 4 as \tilde{Q}^{(τ)}=[\tilde{c}⁽¹⁾, . . . , \tilde{c}^{(τ-1)}, y⁽¹⁾, . . . , y^{(τ)}].

At lines 6 to 10, the knowledge vector \tilde{Q}^{(τ)} 130 is pre-processed, that is, Sₑ(⋅) generates l equal-sized knowledge vectors, i.e., Sₑ(\tilde{Q}^{(τ)})={\tilde{Q}ᵢ^{(τ)}, . . . , \tilde{Q}ₗ^{(τ)}}, each of which corresponds to respective different blocks, such that each knowledge vector is determined according to whether or not Parity only should be taken into account or if previously transmitted feedback symbols should be taken into account as well as parity. It can be appreciated that from the perspective of the encoder 132 of node B 104, the received signals correspond to or represent parity symbols and the feedback symbols correspond to or represent transmitted signals.

If parity only is active, then each of the l knowledge vectors is determined from \tilde{Q}ᵢ^{(τ)}=[yᵢ⁽¹⁾, . . . , yᵢ^{(τ)}] as can be appreciated from line 8. If parity only is not active, then each of the l knowledge vectors also takes into account the previous feedback symbols such that each of the l knowledge vectors is determined from \tilde{Q}ᵢ^{(τ)}=[\tilde{c}ᵢ⁽¹⁾, . . . , \tilde{c}ᵢ^{(τ-1)}, yᵢ⁽¹⁾, . . . , yᵢ^{(τ)}] as can be appreciated at line 10.

The knowledge vectors \tilde{Q}ᵢ^{(τ)}, . . . , \tilde{Q}ₗ^{(τ)} are processed at lines 12 and 13 to extract the features \tilde{V}ᵢ^{(τ)}=\tilde{H}_{extract}^{feedback}(\tilde{Q}ᵢ^{(τ)}). Sequence to Sequence processing, via an attention-based neural network, as described above in respect of the encoder 122 of node A 102, is performed at line 14 via \tilde{W}^{(τ)}=\tilde{H}ₛ₂ₛ^{feedback}(\tilde{V}^{(τ)}).

Finally, feedback symbol mapping is performed at lines 16 and 17 to establish the feedback symbols 116 via \tilde{c}ᵢ^{(τ)}=\tilde{H}ₘₐₚ^{feedback}(\tilde{W}ᵢ^{(τ)}), which are outputs for transmission to node A 102.

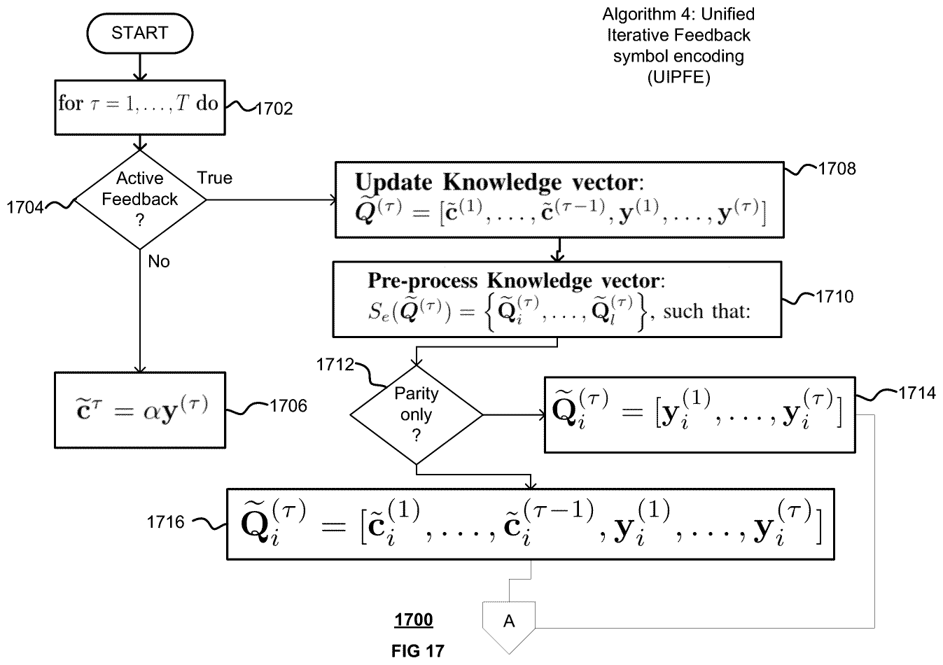

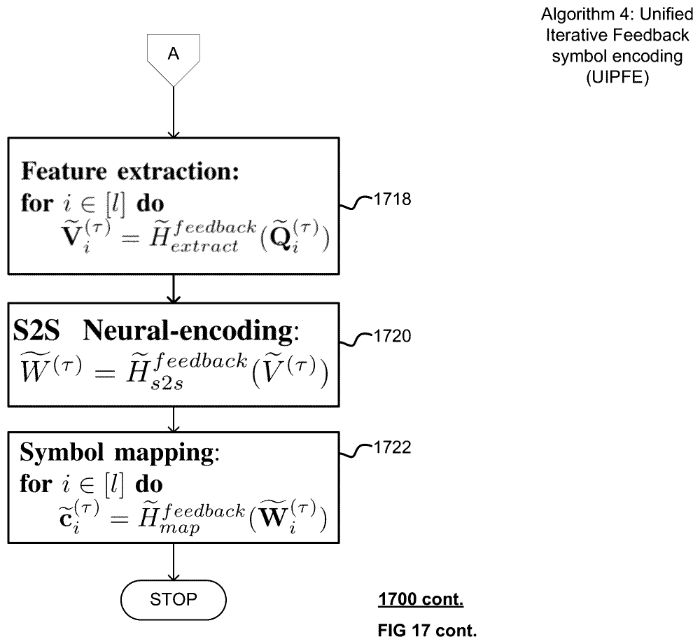

Referring to FIG. 17, there is shown a flowchart 1700 for implementing Algorithm 4. At 1702, a for loop is established at line 1 so that a feedback symbol per block is generated at each pass. A determination is made, at 1704, regarding whether or not active feedback is enabled. If active feedback is not enabled, the τ^{th} feedback symbol c^{τ} is determined, at 1706, from the received signal. Examples can be realised in which the τ^{th} feedback symbol c^{τ} is determined as a scaled version of the (τ−1)^{th} received signal αy^{(τ-1)}. If active feedback is enabled, the information vector or knowledge vector \tilde{Q}^{(τ)} 130 is updated, at 1708, as \tilde{Q}^{(τ)}=[\tilde{c}⁽¹⁾, . . . , \tilde{c}^{(τ-1)}, y⁽¹⁾, . . . , y^{(τ)}].

At 1710, the knowledge vector \tilde{Q}^{(τ)} 130 is pre-processed, that is, Sₑ(⋅) generates l equal-sized knowledge vectors, i.e., Sₑ(\tilde{Q}^{(τ)})={\tilde{Q}ᵢ^{(τ)}, . . . , \tilde{Q}ₗ^{(τ)}}, each of which corresponds to respective different blocks, such that each knowledge vector is determined according to whether or not Parity only should be taken into account or if previously transmitted feedback symbols should be taken into account as well as parity. It can be appreciated that from the perspective of the encoder 132 of node B 104, the received signals correspond to or represent parity symbols and the feedback symbols correspond to or represent transmitted signals.

Therefore, a determination is, at 1712, if parity only is active. If the determination at 1712 is that parity only is active, then each of the/knowledge vectors is determined, at 1714, from \tilde{Q}ᵢ^{(τ)}=[yᵢ⁽¹⁾, . . . , yᵢ^{(τ)}]. However, if parity only in not active, then each of the l knowledge vectors also takes into account the previous feedback symbols such that each of the l knowledge vectors is determined, at 1716, from \tilde{Q}ᵢ^{(τ)}=[\tilde{c}ᵢ⁽¹⁾, . . . , \tilde{c}ᵢ^{(τ-1)}, yᵢ⁽¹⁾, . . . , yᵢ^{(τ)}].

The knowledge vectors \tilde{Q}ᵢ^{(τ)}, . . . , \tilde{Q}ₗ^{(τ)} are processed, at 1718, to extract the features \tilde{V}ᵢ^{(τ)}=\tilde{H}_{extract}^{feedback}(\tilde{Q}ᵢ^{(τ)}). Sequence to Sequence processing, via an attention-based neural network, as described above in respect of the encoder 122 of node A 102, is performed, at 1720, via \tilde{W}^{(τ)}=\tilde{H}ₛ₂ₛ^{feedback}(\tilde{V}^{(τ)}).

Finally, feedback symbol mapping is performed, at 1722, to establish the feedback symbols 116 via \tilde{c}ᵢ^{(τ)}=\tilde{H}ₘₐₚ^{feedback}(\tilde{W}ᵢ^{(τ)}), which are outputs for transmitting node A 102.

The functionality of the system 100 and any parts thereof can be realised in the form of machine instructions that can be processed by a machine comprising or having access to the instructions. The machine can comprise a computer, processor, processor core, DSP, a special purpose processor implementing the instructions such as, for example, an FPGA or an ASIC, circuitry or other logic, compiler, translator, interpreter or any other instruction processor. Processing the instructions can comprise interpreting, executing, converting, translating or otherwise giving effect to the instructions. The instructions can be stored on a machine readable medium, which is an example of machine-readable storage. The machine-readable medium can store the instructions in a non-volatile, non-transient or non-transitory, manner or in a volatile, transient, manner, where the term ‘non-transitory’ does not encompass transitory propagating signals. The instructions can be arranged to give effect to any and all operations described herein taken jointly and severally in any and all permutations. The instructions can be arranged to give effect to any and all of the operations, devices, systems, flowcharts, protocols or methods described herein taken jointly and severally in any and all permutations. In particular, the machine instructions can give effect to, or otherwise implement, the operations of the algorithms and/or flowcharts depicted in, or described with reference to, FIGS. 4, 14, 15, 16 and 17, taken jointly and severally in any and all permutations.

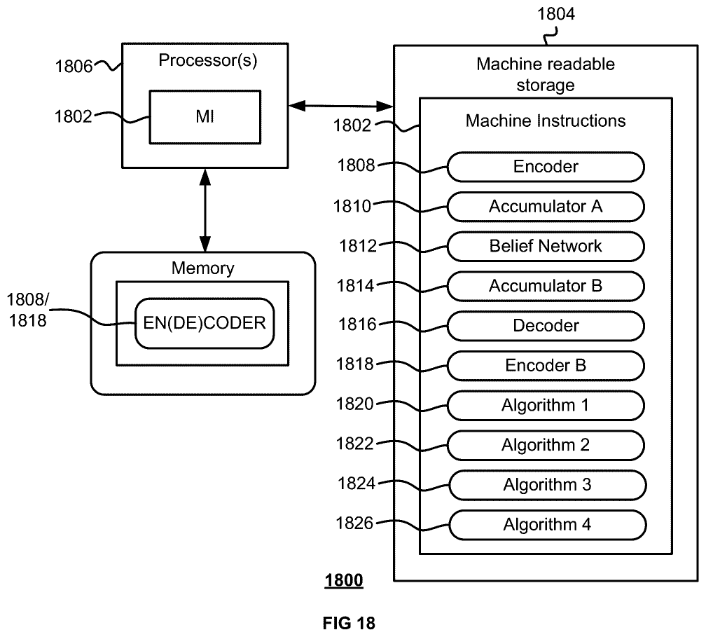

Therefore, FIG. 18 shows a view 1800 of machine instructions 1802 stored using machine readable storage 1804 for implementing the examples described herein. The machine instructions 1802 can be processed by, for example, a processor 1806 or other processing entity, such as, for example, an interpreter, as indicated above.

The machine instructions 1802 comprise at least one or more than one of:

Instructions 1808 to realise an encoder,

Instructions 1810 to implement an accumulator at node A 102,

Instructions 1812 to implement a belief neural network,

Instructions 1814 to realise an accumulator at node B 104,

Instructions 1816 to implement a decoder,

Instructions 1818 to realise an encoder at node B 104

Instructions 1820 to implement Algorithm 1,

Instructions 1822 to implement Algorithm 2,

Instructions 1824 to implement Algorithm 3, and

Instructions 1826 to implement Algorithm 4.

the foregoing instructions 1808 to 1826 being taken jointly and severally in any and all permutations.

Advantageously, one or more than one of the examples described herein address or otherwise solve the following limitations of existing deep neural networks:
Communication overhead: In practice, each distinct use of the forward and feedback channels introduces a certain level of overhead and an additional delay independent of the number of bits transmitted. The corresponding communication overhead is defined as the number of ‘switches’ at the transmitter, between transmitting parity symbols and receiving feedback symbols. In existing schemes, each time Hd is used, only two symbols are generated and transmitted. Hence, the communication overhead scales with the length of the bit-stream K.
Limited range of feasible rates: Existing schemes are limited to rates

$$\frac{1}{k} ,$$

k∈Z⁺.
DeepCode is a systematic feedback scheme or architecture, which is limiting.

Examples can be realised in accordance with the following clauses:

Clause 1: An encoding method for a modulator of a transmitter to encode a source bitstream b∈{0,1}^{K×1} comprising K source bits using feedback encoding; the method comprising:

dividing the source bitstream into l=[K/m] groups of size m, such that b=[s₁^{T}, s₂^{T}, . . . , sₗ^{T}];

constructing a feature matrix,

$${Q}^{( τ )} = [ \begin{matrix}{F}_{b} \\ {F}_{c} \\ {F}_{n}\end{matrix} ] ,$$

where F_{b} comprises the source bits, the feature matrix also comprising at least selectable ones of: pairs of previously transmitted coded symbols, F_{c}, and estimated noise realisations, Fₙ, optionally, selectable ones of tuples of source bits, previously transmitted coded symbols, F_{c}, and estimated noise realisations, Fₙ, received via a-feedback signal transmitted by a receiver;

encoding the feature matrix, using attention-based neural sequence to sequence

(s2s) mapping, to generate a vector of l coded symbols, and

outputting the l coded symbols for transmitting to the receiver.

Clause 2: The method of clause 1, in which encoding the feature matrix to generate a vector of l coded symbols comprises:

preprocessing the feature matrix to extract a set of features that will influence encoding the feature matrix,

transforming (s2s), using an attention encoder, the feature matrix, Q^{(τ)}, into a sequence to establish new correlations between portions of the feature matrix using existing correlations between portions of the feature matrix, and

mapping the sequence into l coded symbols.

Clause 3: The method of clause 2, in which the transforming comprises transforming (s2s), using the attention encoder, the feature matrix, Q^{(τ)}, into the sequence to establish new column-wise correlations between columns of the feature matrix using existing column-wise correlations between columns of the feature matrix.

Clause 4: The method of any preceding clause, in which constructing the feature matrix,

$${Q}^{( τ )} = [ \begin{matrix}{F}_{b} \\ {F}_{c} \\ {F}_{n}\end{matrix} ] ,$$

comprising the source bits, previously transmitted coded symbols and estimated noise realisations received at the transmitter comprises:

generating a vector F_{b}∈{0,1}^{m×1}, comprising the l groups of m source bits, F_{b}=[s₁, s₂, . . . sₗ].

Clause 5: The method of any preceding clause, in which constructing the feature matrix,

$${Q}^{( τ )} = [ \begin{matrix}{F}_{b} \\ {F}_{c} \\ {F}_{n}\end{matrix} ] ,$$

comprising the source bits, previously transmitted coded symbols and estimated noise realisations received at the transmitter comprises:

generating a vector F_{c}∈R^{(τ-1)×l} comprising the previously transmitted coded symbols; each row of F_{c} comprising c⁽ⁱ⁾, for i=1, . . . , τ−1, and zero-padded for i=τ, . . . , T−1, where τ is a temporal index of order of the previously transmitted symbols;

$${F}_{c} = [ \begin{matrix}{( {c}^{( 1 )} )}^{⊤} \\ {( {c}^{( 2 )} )}^{⊤} \\ … \\ \begin{matrix}{( {c}^{( τ ‐ 1 )} )}^{⊤} \\ …\end{matrix} \\ \begin{matrix}{0}_{1 xl} \\ …\end{matrix} \\ {0}_{1 xl}\end{matrix} ] .$$

Clause 6: The method of any preceding clause, in which constructing the feature matrix,

$${Q}^{( τ )} = [ \begin{matrix}{F}_{b} \\ {F}_{c} \\ {F}_{n}\end{matrix} ] ,$$

comprising the source bits, previously transmitted coded symbols and estimated noise realisations received at the transmitter comprises:

generating a vector of estimated noise realisations Fₙ∈R^{(τ-1)×l} observed at the feedback channel of the transmitter, such that

$${F}_{n} = [ \begin{matrix}{( {\overline{n}}^{( 1 )} )}^{⊤} \\ {( {\overline{n}}^{( 2 )} )}^{⊤} \\ … \\ {( {\overline{n}}^{( τ ‐ 1 )} )}^{⊤} \\ \begin{matrix}… \\ {0}_{1 xl} \\ …\end{matrix} \\ {0}_{1 xl}\end{matrix} ] ,$$

from the received feedback signal.

Clause 7: The method of any preceding clause in which outputting the 1 coded symbols for transmitting to the receiver comprises at least one, or both, of power normalisation and power reallocation to generate the l coded symbols c^{(τ)}∈R^{1×l}.

Clause 8: A decoding method for a demodulator of a receiver to decode a coded symbol stream comprising T symbols C^{(τ)}, τ=1, 2, . . . , T, iteratively derived from a bitstream b∈{0,1}^{K×1} comprising K source bits arranged into l=┌K/m┐ groups of size m, such that b=[s₁^{T}, s₂^{T}, . . . , sₗ^{T}] using feedback provided by the receiver; the decoding method comprising:

progressively/iteratively

receiving a current signal of a plurality of signals

$${y}^{( τ )} ∈ {R}^{\frac{K}{R}} ,$$

y^{(τ)}=c^{(τ)}+n^{(τ)}; c^{(τ)}, n^{(τ)}∈R^{1×l}, comprising the T symbols; and

transmitting received symbols, c^{(τ)}, or the currently/most recently received signal, y^{(τ)}, comprising a currently/most recently received symbol, c^{(τ)}, to a transmitter associated with generating the symbols, c^{(τ)};

constructing a feature matrix,

$${\tilde{Q}}^{( τ )} = [ \begin{matrix}{( {y}^{( 1 )} )}^{⊤} \\ {( {y}^{( 2 )} )}^{⊤} \\ … \\ {( {y}^{( τ ‐ 1 )} )}^{⊤} \\ … \\ {( {y}^{( T ‐ 1 )} )}^{⊤} \\ {( {y}^{( T )} )}^{⊤}\end{matrix} ] ,$$

using the plurality of signals, y^{(τ)}, comprising the T symbols, c^{(τ)}, by progressively accumulating (y^{(τ)})^{T} for τ=1, 2, . . . , T; and

generating a decoded bitstream vector \hat{b}∈{0,1}^{K}, comprising the l groups of m source bits, \hat{b}=[s₁, s₂, . . . sₗ], from the feature matrix, \tilde{Q}^{(τ)}, using a sequence to sequence neural network/attention neural network.

Clause 9: The method of clause 8, in which generating the decoded bitstream vector \hat{b}, comprising the l groups of m source bits, \hat{b}=[s₁, s₂, . . . sₗ], from the feature matrix, \tilde{Q}^{(τ)}, comprises:

preprocessing the feature matrix, \tilde{Q}^{(τ)}, to extract a set of features, \tilde{V}∈R^{bsxlx}, for influencing generating the decoded bitstream;

transforming (s2s), using an attention encoder, the feature matrix, \tilde{Q}^{(τ)}, into a sequence to using correlations between portions of the feature matrix, and

mapping the sequence into the l decoded symbols.

Clause 10: The method of clause 9, in which transforming (s2s), using an attention encoder, the feature matrix, \tilde{Q}^{(τ)}, into a sequence to using correlations between portions of the feature matrix comprises

transforming (s2s), using an attention encoder, the feature matrix, \tilde{Q}^{(τ)}, into a sequence using column-wise correlations between columns of the feature matrix.

Clause 11: The method of any preceding clause in which generating a decoded bitstream vector, \hat{b}, comprises reshaping the output from sequence to sequence neural network/attention neural network.

Clause 12: Machine readable instructions arranged, when processed, to implement a method of any preceding clause.

Clause 13: Machine readable storage storing machine readable instructions of clause 12.

Clause 14: An encoder comprising circuitry arranged to implement a method of any of clauses 1 to 7.

Clause 15: A decoder comprising circuitry arranged to implement a method of any of clauses 8 to 11.

1. Non-transitory machine readable storage storing machine readable instructions for an encoding method for a modulator of a transmitter to encode a source bitstream b∈{0,1}^{K×1} comprising K source bits using feedback encoding; the instructions comprising instructions to:
a. divide the source bitstream into l=┌K/m┐ groups of size m, such that b=[s₁^{T}, s₂^{T}, . . . , sₗ^{T}];
b. construct a feature matrix,
$${Q}^{( τ )} = [ \begin{matrix}{F}_{b} \\ {F}_{c} \\ {F}_{n}\end{matrix} ] ,$$
where F_{b} comprises the source bits, the feature matrix also comprising at least selectable ones of:
i. previously transmitted coded symbols, F_{c}, and estimated noise realisations, Fₙ,
received via a-feedback signal transmitted by a receiver;
c. encode the feature matrix, using attention-based neural sequence to sequence (s2s) mapping, to generate a vector of l coded symbols, and
d. output the l coded symbols for transmitting to the receiver.

2. The non-transitory machine readable storage of claim 1, in which the instructions to encode the feature matrix to generate a vector of l coded symbols comprise instructions to:
a. preprocess the feature matrix to extract a set of features that will influence encoding the feature matrix,
b. transform (s2s), using an attention encoder, the feature matrix, Q^{(τ)}, into a sequence to establish new correlations between portions of the feature matrix using existing correlations between portions of the feature matrix, and
c. map the sequence into l coded symbols.

3. The non-transitory machine readable storage of claim 2, in which the instructions to transform comprise instructions to transform (s2s), using the attention encoder, the feature matrix, Q^{(τ)}, into the sequence to establish new column-wise correlations between columns of the feature matrix using existing column-wise correlations between columns of the feature matrix.

4. The non-transitory machine readable storage of claim 1, in which the instructions to construct the feature matrix,
$${Q}^{( τ )} = [ \begin{matrix}{F}_{b} \\ {F}_{c} \\ {F}_{n}\end{matrix} ] ,$$
comprising the source bits, previously transmitted coded symbols and estimated noise realisations received at the transmitter comprise instructions to:
a. generate a vector F_{b}∈{0,1}^{mxl}, comprising the l groups of m source bits, F_{b}=[s₁, s₂, . . . sₗ].

5. The non-transitory machine readable storage of claim 1, in which the instructions to construct the feature matrix,
$${Q}^{( τ )} = [ \begin{matrix}{F}_{b} \\ {F}_{c} \\ {F}_{n}\end{matrix} ] ,$$
comprising the source bits, previously transmitted coded symbols and estimated noise realisations received at the transmitter comprise instructions to:
a. generate a vector F_{c}∈R^{(τ-1)×l} comprising the previously transmitted coded symbols; each row of F_{c} comprising c⁽ⁱ⁾, for i=1, . . . , τ−1, and zero-padded for i=τ, . . . , T−1, where τ is a temporal index of order of the previously transmitted symbols;
$${F}_{c} = [ \begin{matrix}{( {c}^{( 1 )} )}^{⊤} \\ {( {c}^{( 2 )} )}^{⊤} \\ \begin{matrix}… \\ {( {c}^{( τ ‐ 1 )} )}^{⊤} \\ {0}_{1 xl} \\ …\end{matrix} \\ {0}_{1 xl}\end{matrix} ] .$$

6. The non-transitory machine readable storage of claim 1, in which the instructions to construct the feature matrix,
$${Q}^{( τ )} = [ \begin{matrix}{F}_{b} \\ {F}_{c} \\ {F}_{n}\end{matrix} ] ,$$
comprising the source bits, previously transmitted coded symbols and estimated noise realisations received at the transmitter comprise instructions to:
a. generate a vector of estimated noise realisations Fₙ∈R^{(τ-1)×l} observed at the feedback channel of the transmitter, such that
$${F}_{n} = [ \begin{matrix}{( {\overline{n}}^{( 1 )} )}^{⊤} \\ {( {\overline{n}}^{( 2 )} )}^{⊤} \\ \begin{matrix}… \\ {( {\overline{n}}^{( τ ‐ 1 )} )}^{⊤} \\ {0}_{1 xl} \\ …\end{matrix} \\ {0}_{1 xl}\end{matrix} ] ,$$
from the received feedback signal.

7. The non-transitory machine readable storage of claim 1 in which the instructions to output the 1 coded symbols for transmitting to the receiver comprises at least one, or both, of: instructions for power normalisation and instructions for power reallocation to generate the l coded symbols c^{(τ)}∈R^{1×l}.

8. Non-transitory machine readable storage storing instructions for a decoding method for a demodulator of a receiver to decode a coded symbol stream comprising T symbols c^{(τ)}, τ=1, 2, . . . , T, iteratively derived from a bitstream b∈{0,1}^{K×1} comprising K source bits arranged into l=┌K/m┐ groups of size m, such that b=[s₁^{T}, s₂^{T}, . . . , sₗ^{T}] using feedback provided by the receiver; the instructions comprising instructions to:
a. progressively/iteratively
i. receive a current signal of a plurality of signals
$${\tilde{Q}}^{( τ )} = [ \begin{matrix}{( {y}^{( 1 )} )}^{⊤} \\ {( {y}^{( 2 )} )}^{⊤} \\ … \\ {( {y}^{( τ ‐ 1 )} )}^{⊤} \\ … \\ {( {y}^{( T ‐ 1 )} )}^{⊤} \\ {( {y}^{( T )} )}^{⊤}\end{matrix} ] ,$$
y^{(τ)}=c^{(τ)}+n^{(τ)}; c^{(τ)}, n^{(τ)}∈R^{1×l}, comprising the T symbols; and
ii. transmit received symbols, c^{(τ)}, or the currently/most recently received signal, y^{(τ)}, comprising a currently/most recently received symbol, c^{(τ)}, to a transmitter associated with generating the symbols, c^{(τ)};
b. construct a feature matrix,
$${y}^{( τ )} ∈ {R}^{\frac{K}{R}} ,$$
using the plurality of signals, y^{(τ)}, comprising the T symbols, c^{(τ)}, by progressively accumulating (y^{(τ)})^{T} for τ=1, 2, . . . , T; and
c. generate a decoded bitstream vector \hat{b}∈{0,1}^{K}, comprising the l groups of m source bits, \hat{b}=[s₁, s₂, . . . sₗ], from the feature matrix, \tilde{Q}^{(τ)}, using a sequence to sequence neural network/attention neural network.

9. The non-transitory machine readable storage of claim 8, in which the instructions to generate the decoded bitstream vector \hat{b}, comprising the l groups of m source bits, \hat{b}=[s₁, s₂, . . . sₗ], from the feature matrix, \tilde{Q}^{(τ)}, comprise instructions to:
a. preprocess the feature matrix, \tilde{Q}^{(τ)}, to extract a set of features, \tilde{V}∈R^{bsxlx}, for influencing generating the decoded bitstream;
b. transform (s2s), using an attention encoder, the feature matrix, \tilde{Q}^{(τ)}, into a sequence to using correlations between portions of the feature matrix, and
c. map the sequence into the l decoded symbols.

10. The non-transitory machine readable storage of claim 9, in which the instructions to transform (s2s), using an attention encoder, the feature matrix, \tilde{Q}^{(τ)}, into a sequence to using correlations between portions of the feature matrix comprise instructions to:
a. transform (s2s), using an attention encoder, the feature matrix, \tilde{Q}^{(τ)}, into a sequence using column-wise correlations between columns of the feature matrix.

11. The non-transitory machine readable storage of claim 8 in which the instructions to generate a decoded bitstream vector, \hat{b}, comprise instructions to reshape the output from sequence to sequence neural network/attention neural network.

12. An encoder to encode a source bitstream b∈{0,1}^{K×1} comprising K source bits using feedback encoding; the encoder comprising circuitry to:
a. divide the source bitstream into l=┌K/m┐ groups of size m, such that b=[s₁^{T}, s₂^{T}, . . . , sₗ^{T}];
b. construct a feature matrix,
$${Q}^{( τ )} = [ \begin{matrix}{F}_{b} \\ {F}_{c} \\ {F}_{n}\end{matrix} ] ,$$
where F_{b} comprises the source bits, the feature matrix also comprising at least selectable ones of
i. previously transmitted coded symbols, F_{c},
ii. estimated noise realisations, Fₙ,
received via a-feedback signal transmitted by a receiver;
c. encode the feature matrix, using attention-based neural sequence to sequence (s2s) mapping, to generate a vector of l coded symbols, and
d. output the l coded symbols for transmitting to the receiver.

13. The encoder of claim 12, in which the circuitry to encode the feature matrix to generate a vector of l coded symbols comprises circuitry to:
a. preprocess the feature matrix to extract a set of features that will influence encoding the feature matrix,
b. transform (s2s), using an attention encoder, the feature matrix, Q^{(τ)}, into a sequence to establish new correlations between portions of the feature matrix using existing correlations between portions of the feature matrix, and
c. map the sequence into l coded symbols.

14. The encoder of claim 13, in which the circuitry to transform comprises circuitry to transform (s2s), using the attention encoder, the feature matrix, Q^{(τ)}, into the sequence to establish new column-wise correlations between columns of the feature matrix using existing column-wise correlations between columns of the feature matrix.

15. The encoder of claim 12, in which the circuitry to construct the feature matrix,
$${Q}^{( τ )} = [ \begin{matrix}{F}_{b} \\ {F}_{c} \\ {F}_{n}\end{matrix} ] ,$$
comprising the source bits, previously transmitted coded symbols and estimated noise realisations received at the transmitter comprises circuitry to:
a. generate a vector F_{b}∈{0,1}^{mxl}, comprising the l groups of m source bits, F_{b}=[s₁, S₂, . . . sₗ].

16. The encoder of claim 12, in which the circuitry to construct the feature matrix,
$${Q}^{( τ )} = [ \begin{matrix}{F}_{b} \\ {F}_{c} \\ {F}_{n}\end{matrix} ] ,$$
comprising the source bits, previously transmitted coded symbols and estimated noise realisations received at the transmitter comprises circuitry to:
a. generate a vector F_{c}∈R^{(τ-1)×l} comprising the previously transmitted coded symbols; each row of F_{c} comprising c⁽ⁱ⁾, for i=1, . . . , τ−1, and zero-padded for i=τ, . . . , T−1, where τ is a temporal index of order of the previously transmitted symbols;
$${F}_{c} = [ \begin{matrix}{( {c}^{( 1 )} )}^{⊤} \\ {( {c}^{( 2 )} )}^{⊤} \\ \begin{matrix}… \\ {( {c}^{( τ ‐ 1 )} )}^{⊤} \\ {0}_{1 xl} \\ …\end{matrix} \\ {0}_{1 xl}\end{matrix} ] .$$

17. The encoder of claim 12, in which the circuitry to construct the feature matrix,
$${Q}^{( τ )} = [ \begin{matrix}{F}_{b} \\ {F}_{c} \\ {F}_{n}\end{matrix} ] ,$$
comprising the source bits, previously transmitted coded symbols and estimated noise realisations received at the transmitter comprises circuitry to:
a. generate a vector of estimated noise realisations Fₙ∈R^{(τ-1)×l} observed at the feedback channel of the transmitter, such that
$${F}_{n} = [ \begin{matrix}{( {\overline{n}}^{( 1 )} )}^{⊤} \\ {( {\overline{n}}^{( 2 )} )}^{⊤} \\ \begin{matrix}… \\ {( {\overline{n}}^{( τ ‐ 1 )} )}^{⊤} \\ {0}_{1 xl} \\ …\end{matrix} \\ {0}_{1 xl}\end{matrix} ] ,$$
from the received feedback signal.

18. A decoder to decode a coded symbol stream comprising T symbols c^{(τ)}, τ=1, 2, . . . , T, iteratively derived from a bitstream b∈{0,1}^{K×1} comprising K source bits arranged into l=┌K/m┐ groups of size m, such that b=[s₁^{T}, s₂^{T}, . . . , sₗ^{T}] using feedback provided by the receiver; the decoder comprising circuitry to:
a. progressively/iteratively
i. receive a current signal of a plurality of signals
$${y}^{( τ )} ∈ {R}^{\frac{K}{R}} ,$$
y^{(τ)}=c^{(τ)}+n^{(τ)}; c^{(τ)}, n^{(τ)}∈R^{1×l}, comprising the T symbols; and
ii. transmit received symbols, c^{(τ)}, or the currently/most recently received signal, y^{(τ)}, comprising a currently/most recently received symbol, c^{(τ)}, to a transmitter associated with generating the symbols, c^{(τ)};
b. construct a feature matrix,
$${\tilde{Q}}^{( τ )} = [ \begin{matrix}{( {y}^{( 1 )} )}^{⊤} \\ {( {y}^{( 2 )} )}^{⊤} \\ … \\ {( {y}^{( τ ‐ 1 )} )}^{⊤} \\ … \\ {( {y}^{( T ‐ 1 )} )}^{⊤} \\ {( {y}^{( T )} )}^{⊤}\end{matrix} ] ,$$
using the plurality of signals, y^{(τ)}, comprising the T symbols, c^{(τ)}, by progressively accumulating (y^{(τ)})^{T} for τ=1, 2, . . . , T; and
c. generate a decoded bitstream vector \hat{b}∈{0,1}^{K}, comprising the l groups of m source bits, \hat{b}=[s₁, s₂, . . . sₗ], from the feature matrix, \tilde{Q}^{(τ)}, using a sequence to sequence neural network/attention neural network.

19. The decoder of claim 18, in which the circuitry to generate the decoded bitstream vector \hat{b}, comprising the l groups of m source bits, \hat{b}=[s₁, s₂, . . . sₗ], from the feature matrix, \tilde{Q}^{(τ)}, comprises circuitry to:
a. preprocess the feature matrix, \tilde{Q}^{(τ)}, to extract a set of features, \tilde{V}∈R^{bsxlx}, for influencing generating the decoded bitstream;
b. transform (s2s), using an attention encoder, the feature matrix, \tilde{Q}^{(τ)}, into a sequence to using correlations between portions of the feature matrix, and
c. map the sequence into the l decoded symbols.
